(19) United States
(12) Patent Application Publication
(10) Pub. No.: US 2016/0204465 A1
(43) Pub. Date: Jul. 14, 2016

(54) SOLID ELECTROLYTE COMPOSITION, ELECTRODE SHEET FOR BATTERIES USING SAME AND ALL-SOLID-STATE SECONDARY BATTERY

(71) Applicant: FUJIFILM Corporation, Tokyo (JP)

(72) Inventors: Tomonori MIMURA, Ashigarakami-gun (JP); Hiroaki MOCHIZUKI, Ashigarakami-gun (JP); Masaomi MAKINO, Ashigarakami-gun (JP)

(73) Assignee: FUJIFILM Corporation, Tokyo (JP)

(21) Appl. No.: 15/075,589

(22) Filed: Mar. 21, 2016

Related U.S. Application Data
(63) Continuation of application No. PCT/JP2014/075399, filed on Sep. 25, 2014.

(30) Foreign Application Priority Data
Sep. 25, 2013 (JP) 2013-198397

(51) Int. Cl. H01M 10/056; H01M 4/62

(52) U.S. Cl. CPC H01M 10/056; H01M 4/622; H01M 2300/0068

(57) ABSTRACT

Provided is a solid electrolyte composition including: an inorganic solid electrolyte (A) having conductivity of an ion of metal belong to Group 1 or 2 in the periodic table; binder particles (B) which is formed of a polymer combined with a macromonomer (X) including a side chain component having a number average molecular weight of 1,000 or greater, and which has an average diameter of 10 nm to 1,000 nm, and a dispersion medium (C).

### CROSS-REFERENCE TO RELATED APPLICATIONS

This application is a Continuation of PCT International Application No. PCT/JP2014/075399 filed on Sep. 25, 2014, which claims priority under 35 U.S.C. §119 (a) to Japanese Patent Application No. 2013-198397 filed in Japan on Sep. 25, 2013. Each of the above applications is hereby expressly incorporated by reference, in its entirety, into the present application.

### BACKGROUND OF THE INVENTION

1. Field of the Invention

The present invention relates to a solid electrolyte composition, an electrode sheet for batteries using the same, and an all-solid-state secondary battery.

2. Description of the Related Art

An electrolyte solution is used in a lithium-ion battery. There has been an attempt to make an all-solid-state secondary battery in which all configuration materials are solid by substituting the electrolyte solution with a solid electrolyte. Above all, one of the advantages of the technique of using an inorganic solid electrolyte is reliability. As a medium of the electrolyte solution, a combustible material such as a carbonate-based solvent is applied to the electrolyte solution used in the lithium-ion secondary battery. Various safety measures are employed, but there is a concern that inconvenience may occur when a battery is overcharged, and an additional measurement is desired. An all-solid-state secondary battery formed of an inorganic compound that can cause an electrolyte to be incombustible is regarded as a fundamental solution thereof.

Another advantage of the all-solid-state secondary battery is that a high energy density is suitably achieved by stacking electrodes. Specifically, the all-solid-state secondary battery can be a battery having a structure in which electrodes and electrolytes are directly arranged side by side to be serialized. At this point, a metal package that seals battery cells and a copper wire or a bus bar that connects battery cells can be omitted, and thus an energy density of the battery can be greatly increased. In addition, it is advantageous that good compatibility with a positive electrode material in which a potential can be enhanced to a high level.

According to the respective advantages as described above, the development of the all-solid-state secondary battery as a next-generation lithium-ion secondary battery is energetically advanced (see NEDO: New Energy and Industrial Technology Development Organization, Fuel Cells•Hydrogen Technology Development Field, Electricity Storage Technology Development Section “NEDO Technology Development Roadmap of Battery for New Generation Vehicles 2008” (June 2009)). Meanwhile, the inorganic all-solid-state secondary battery has a disadvantage caused by the fact that the electrolyte thereof is a hard solid. For example, interface resistance between solid particles or between solid particles and a collector increases. In order to overcome this disadvantage, a method of sintering a solid electrolyte in a high temperature (JP2008-059843A), a method of using a jig for pressurizing a cell (JP2008-103284A), a method of covering the entire element with a resin and pressurizing the entire element (JP2000-106154A), a method of pressurizing and baking a green sheet including a solid electrolyte (JP2012-186181A), and the like are suggested. Otherwise, there is an example in which a binder to be mixed with an inorganic material is chosen in order to prevent degeneration of a positive electrode material (JP2012-099315A), in order to prevent separation of an electrode material due to a volume change of an active substance accompanied by charging and discharging (JP2011-134675A), and in order to improve binding properties (JP2013-008611A).

### SUMMARY OF THE INVENTION

According to the conception of JP2008-059843A, JP2008-103284A, JP2000-106154A, and JP2012-186181A, an increase of interface resistance in the all-solid-state secondary battery may be improved in its own way, but a method relying on a physical power “pressurization” is desired to be avoided as much as possible. In addition, the improvement of all characteristics by the binder disclosed in JP2012-099315A, JP2011-134675A, and JP2013-008611A is also estimated, but the improvement is not sufficient as an improvement effect relating to interface resistance and the like, and further improvement is desired.

Therefore, an object of the invention is to provide a solid electrolyte composition that can prevent an increase of interface resistance between solid particles and between solid particles and a collector, not by performing pressurization and that can realize satisfactory binding properties in the all-solid-state secondary battery, an electrode sheet for batteries using the solid electrolyte composition, and an all-solid-state secondary battery.

The object described above is achieved by the following means.

[1] A solid electrolyte composition including: an inorganic solid electrolyte (A) having conductivity of an ion of metal belong to Group 1 or 2 in the periodic table; binder particles (B) formed of a polymer combined with a macromonomer (X) having a number average molecular weight of 1,000 or greater, as a side chain component, and which has an average diameter of 10 nm to 1,000 nm; and a dispersion medium (C).
[2] The solid electrolyte composition according to [1], in which a polymer that forms in the binder particles (B) is amorphous.
[3] The solid electrolyte composition according to [1] or [2], in which a glass transition temperature (Tg) of the polymer forming the binder particle is 30° C. or lower.
[4] The solid electrolyte composition according to any one of [1] to [3], in which the polymer forming the binder particle has at least one functional group in a group of functional groups (b).

Group of functional groups (b) a carbonyl group, an amino group, a sulfonic acid group, a phosphoric acid group, a hydroxy group, an ether group, a cyano group, and a thiol group

[5] The solid electrolyte composition according to any one of [1] to [4], in which a carbonyl group is included in the polymer forming the binder particle.
[6] The solid electrolyte composition according to any one of [1] to [5], in which a polymer forming the binder particle includes a repeating unit derived from a monomer selected from a (meth)acrylic acid monomer, a (meth)acrylic acid ester monomer, and (meth)acrylonitrile.
[7] The solid electrolyte composition according to any one of [1] to [6], in which an average diameter of the binder particles (B) is 200 nm or lower.
[8] The solid electrolyte composition according to any one of [1] to [7], in which a ratio of a repeating unit derived from the macromonomer (X) in the polymer forming the binder particles (B) is 50 mass % or lower or 1 mass % or greater.
[9] The solid electrolyte composition according to any one of [1] to [8], in which a SP value of the macromonomer (X) is 10 or lower.
[10] The solid electrolyte composition according to any one of [1] to [9], in which the macromonomer (X) includes a polymerizable double bond and a straight chain hydrocarbon structure unit having 6 or more carbon atoms.
[11] The solid electrolyte composition according to any one of [1] to [10], in which the macromonomer (X) is a monomer expressed by any one of Formulae (b-13a) to (b-13c) below or a monomer having a repeating unit expressed by any one of Formulae (b-14a) to (b-14c),

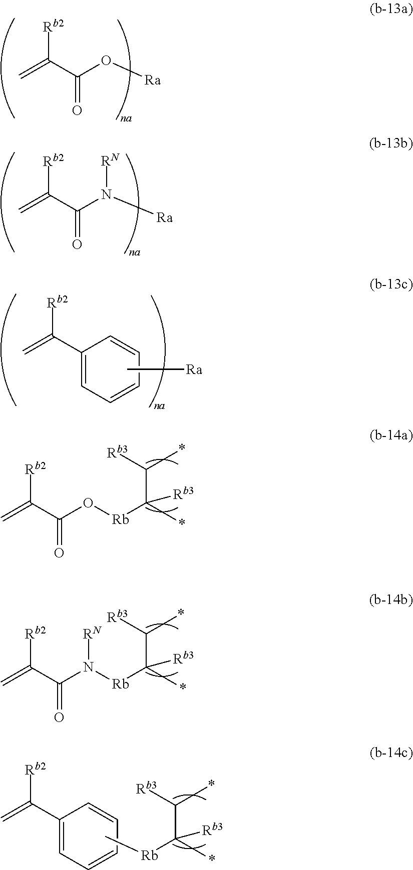

in the formulae, each of R^{b2} and R^{b3} independently represents a hydrogen atom, a hydroxy group, a cyano group, a halogen atom, an alkyl group, an alkenyl group, an alkynyl group, or an aryl group, each of Ra and Rb independently represents a linking group, but, when na is 1, Ra is a univalent substituent, na represents an integer of 1 to 6, and R^{N} is a hydrogen atom or a substituent.

[12] The solid electrolyte composition according to any one of [1] to [11], further including: an active substance that can insert or emit an ion of metal belonging to Group 1 or 2 of the periodic table.
[13] The solid electrolyte composition according to any one of [1] to [12], in which a content of the binder particles (B) is 0.1 parts by mass to 20 parts by mass with respect to 100 parts by mass of the solid electrolyte (A).
[14] The solid electrolyte composition according to any one of [1] to [13], in which the dispersion medium (C) is selected from an alcohol compound solvent, an ether compound solvent, an amide compound solvent, a ketone compound solvent, an aromatic compound solvent, an aliphatic compound solvent, and a nitrile compound solvent.
[15] An electrode sheet for batteries, obtained by forming a film of the solid electrolyte composition according to any one of [1] to [14] on metallic foil.
[16] a negative electrode active substance layer; and a solid electrolyte layer, in which at least any one of the positive electrode active substance layer, the negative electrode active substance layer, and the solid electrolyte layer is a layer formed of the solid electrolyte composition according to any one of [1] to [14].
[17] A method of manufacturing an electrode sheet for batteries, including: disposing the solid electrolyte composition according to any one of [1] to [14] on a metallic foil; and forming a film with the solid electrolyte composition.
[18] A method of manufacturing an all-solid-state secondary battery including: manufacturing an all-solid-state secondary battery using the method of manufacturing an electrode sheet for batteries according to [17].

In this specification, when there are plural substituents or linking groups indicated with specific reference symbols, or plural substituents or the like (in the same manner as in the definition of the number of substituents) are simultaneously or alternatively defined, the respective substituents may be identical to or different from each other. In addition, when the plural substituents and the like come close to each other, those may be bonded or condensed to each other to form a ring.

When the solid electrolyte composition according to the invention is used as a solid electrolyte layer of an all-solid-state secondary battery or a material of an active substance layer, the solid electrolyte composition exhibits an excellent effect in the all-solid-state secondary battery in that an increase of interface resistance between solid particles and between solid particles and a collector can be prevented not by performing pressurization and satisfactory binding properties can be realized.

The aforementioned and other characteristics and advantages according to the invention are specifically described with reference to the descriptions below and the accompanied drawings.

### BRIEF DESCRIPTION OF THE DRAWINGS

FIG. 1 is a sectional view schematically illustrating an all-solid-state lithium-ion secondary battery according to a preferred embodiment of the invention.

FIG. 2 is a side sectional view schematically illustrating a test device used in an example.

### DESCRIPTION OF THE PREFERRED EMBODIMENTS

The solid electrolyte composition according to the invention includes an inorganic solid electrolyte (A) and binder particles (B) formed of a polymer having a specific side chain. Hereinafter, a preferred embodiment of the solid electrolyte composition is described, but an example of the all-solid-state secondary battery which is a preferred application form is described first.

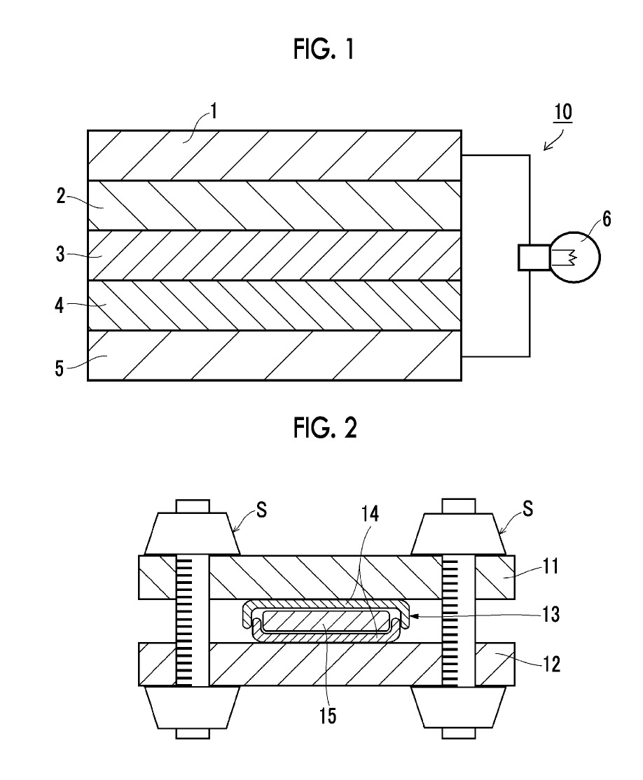

FIG. 1 is a sectional view schematically illustrating an all-solid-state secondary battery (lithium-ion secondary battery) according to a preferred embodiment of the invention. An all-solid-state secondary battery 10 according to the embodiment includes a negative electrode collector 1, a negative electrode active substance layer 2, a solid electrolyte layer 3, a positive electrode active substance layer 4, and a positive electrode collector 5, in this sequence, from the negative electrode side. The respective layers are in contact with each other, and form a stacked structure. If this structure is applied, when the battery is charged, electrons (e⁻) are supplied to a negative electrode side and lithium-ions (Li⁺) are accumulated thereto. Meanwhile, when the battery is discharged, the lithium-ions (Li⁺) accumulated in the negative electrode are returned to the positive electrode side, and electrons are supplied to an operating position 6. In the illustrated example, a bulb is employed in the operating position 6, and the bulb is turned on by the discharge. The solid electrolyte composition according to the invention is preferably used as a configuration material of the negative electrode active substance layer, the positive electrode active substance layer, and the solid electrolyte layer. Among them, the solid electrolyte composition according to the invention is preferably used as a configuration material of all of the solid electrolyte layer, the positive electrode active substance layer, and the negative electrode active substance layer.

Thicknesses of the positive electrode active substance layer 4, the solid electrolyte layer 3, and the negative electrode active substance layer 2 are not particularly limited, and the thicknesses of the positive electrode active substance layer and the negative electrode active substance layer can be arbitrarily determined according to a desired use of the battery. Meanwhile, the solid electrolyte layer is preferably as thin as possible, while short circuits of the positive and negative electrodes are prevented. Specifically, the thickness of the solid electrolyte layer is preferably 1 μm to 1,000 μm and more preferably 3 μm to 400 μm.

In addition, functional layers or members may be inserted or disposed between respective layers of the negative electrode collector 1, the negative electrode active substance layer 2, the solid electrolyte layer 3, the positive electrode active substance layer 4, and the positive electrode collector 5 or on the outside thereof. In addition, the respective layers may be formed with single layers or may be formed with multiple layers.

<Solid Electrolyte Composition>

(Inorganic Solid Electrolyte (A))

The inorganic solid electrolyte is an inorganic solid electrolyte, and the solid electrolyte is a solid-state electrolyte that can enables ions to move inside thereof. In this point of view, the inorganic solid electrolyte may be referred to as an ion conductive inorganic solid electrolyte, in order to differentiate the inorganic solid electrolyte with an electrolyte salt (supporting electrolyte) described below.

Since the inorganic solid electrolyte does not include an organic matter (carbon atom), the inorganic solid electrolyte is clearly differentiated from an organic solid electrolyte (a high polymer electrolyte represented by PEO and the like and an organic electrolyte salt represented by LiTFSI and the like). In addition, the inorganic solid electrolyte is solid in a normal state, and thus is not dissociated or isolated into cations or anions. In this point of view, the inorganic solid electrolyte is clearly differentiated from an inorganic electrolyte salt (LiPF₆, LiBF₄, LiFSI, LiCi, and the like) which is dissociated or isolated into cations or anions in an electrolyte solution or a polymer. The inorganic solid electrolyte is not particularly limited, as long as the inorganic solid electrolyte has conductivity of an ion of metal belonging to Group 1 or 2 in the periodic table and generally does not have electron conductivity.

According to the invention, the inorganic solid electrolyte has conductivity of an ion of metal belonging to Group 1 or 2 in the periodic table. As the inorganic solid electrolyte described above, a solid electrolyte material that is applied to a product of this type can be appropriately chosen to be used. Representative examples of an inorganic solid electrolyte include (i) a sulphide-based inorganic solid electrolyte and (ii) an oxide-based inorganic solid electrolyte.

(i) Sulphide-Based Inorganic Solid Electrolyte

It is preferable that the sulphide solid electrolyte contains sulfur (S), has conductivity of an ion of metal belonging to Group 1 or 2 in the periodic table, and has electron insulation properties. Examples thereof include a lithium-ion conductive inorganic solid electrolyte satisfying the composition presented in Formula (1) below.

LiₐM_{b}P_{c}S_{d} (1)

(In the formula, M represents an element selected from B, Zn, Si, Cu, Ga, and Ge. a to d represent composition ratios of respective elements, and a:b:c:d satisfies 1 to 12:0 to 0.2:1:2 to 9.)

In Formula (1), with respect to the composition ratios of Li, M, P, and S, it is preferable that b is 0, it is more preferable that b=0, and a ratio (a:c:d) of a, c, and d satisfies a:c:d=1 to 9:1:3 to 7, and it is still more preferable that b=0 and a:c:d=1.5 to 4:1:3.25 to 4.5. The composition ratio of the respective elements can be controlled by adjusting a blending amount of raw material compounds when a sulphide-based solid electrolyte is manufactured, as described above.

The sulphide-based solid electrolyte may be amorphous (glass) or may be crystallized (formed into glass ceramic), or a portion thereof may be crystallized.

In Li—P—S-based glass and Li—P—S-based glass ceramics, the ratio of Li₂S and P₂S₅ is preferably 65:35 to 85:15 and more preferably 68:32 to 75:25 in the molar ratio of Li₂S:P₂S₅. If the ratio of Li₂S and P₂S₅ is in the range described above, lithium-ion conductance can be increased. Specifically, the lithium-ion conductance can be preferably 1×10⁻⁴ S/cm or higher and more preferably 1×10⁻³ S/cm or higher.

Specific compound examples thereof include a compound obtained by using a raw material composition containing, for example, Li₂S and sulphide of an element of Groups 13 to 15. Specific examples thereof include Li₂S—P₂S₅, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—Li₃PO₄, and Li₁₀GeP₂S₁₂. Among these, a crystalline and/or amorphous raw material composition formed of Li₂S—P₂S₅, Li₂S—GeS₂—Ga)S₃, Li₂SGeS₂—P₂S₅, Li₂S—SiS₂—P₂S₅, Li₂S—SiS₂—Li₄SiO₄, and Li₂S—SiS₂—Li₃PO₄ is preferable, since the crystalline and/or amorphous raw material composition has high lithium-ion conductivity. Examples of the method of synthesizing a sulphide solid electrolyte material by using such a raw material composition include an amorphizing method. Examples of the amorphizing method include a mechanical milling method and a melt quenching method, and among these, a mechanical milling method is preferable, because a treatment in room temperature becomes possible, and thus the simplification of the manufacturing step is achieved.

(ii) Oxide-Based Inorganic Solid Electrolyte

It is preferable that the oxide-based solid electrolyte contains oxygen (O) has conductivity of an ion of metal belonging to Group 1 or 2 in the periodic table, and has electron insulation properties.

Specific examples of the compound include LiₓLa_{y}TiO₃ [x=0.3 to 0.7 and y=0.3 to 0.7] (LLT), Li₇La₃Zr₂O₁₂ (LLZ), Li₃₅Zn_{0.25}GeO₄ having a lithium super ionic conductor (LISICON)-type crystal structure, La_{0.55}Li_{0.35}TiO₃ having a perovskite-type crystal structure, LiTi₂P₃O₁₂, Li_{1+x+y}(Al,Ga)ₓ(Ti,Ge)₂₋ₓSi_{y}P_{3-y}O₁₂ having a natrium super ionic conductor (NASICON)-type crystal structure (however, 0≦x≦1 and 0≦y≦1), and Li₇La₃Zr₂O₁₂ having a garnet-type crystal structure. In addition, a phosphorus compound including Li, P, and O is desirable. Examples of the phosphorus compound include lithium phosphorate (Li₃PO₄), and LiPON or LiPOD (D is at least one type selected from Ti, V, Cr, Mn, Fe, Co, Ni, Cu, Zr, Nb, Mo, Ru, Ag, Ta, W, Pt, and Au) in which a portion of oxygen in lithium phosphorate is substituted with nitrogen. In addition, LiAON (A is at least one type selected from Si, B, Ge, Al, C, and Ga) and the like can be preferably used.

Among these, Li—La_{y}TiO₃ [x=0.3 to 0.7 and y=0.3 to 0.7] (LLT) and Li₇La₃Zr₂O₁₂ (LLZ) are preferable, since LiₓLa_{y}TiO₃ (LLT) and Li₇La₃Zr₂O₁₂ (LLZ) have high lithium-ion conductivity, are chemically stable, and are easily managed. These may be used singly or two or more types thereof may be used in combination.

The ion conductance of the lithium-ion conductive oxide-based inorganic solid electrolyte is preferably 1×10⁻⁶ S/cm or higher, more preferably 1×10⁻⁵ S/cm or higher, and particularly preferably 5×10⁻⁵ S/cm or higher.

According to the invention, among these, an oxide-based inorganic solid electrolyte is preferably used. Since the oxide-based inorganic solid electrolyte generally has high solidity, the interface resistance in the all-solid-state secondary battery easily increases. If the invention is applied, an effect as a countermeasure thereof becomes prominent.

The average particle diameter of the inorganic solid electrolyte is not particularly limited, but the average particle diameter is preferably 0.01 μm or longer and more preferably 0.1 μm or longer. The upper limit thereof is preferably 100 μm or shorter and more preferably 50 μm or shorter. In addition, a method of measuring an average diameter of the inorganic solid electrolyte particles conforms to a method of measuring an average diameter of inorganic particles described in the section of examples below.

If compatibility between battery properties and a decrease and maintenance effect of the interface resistance is considered, the concentration in the solid electrolyte composition of the inorganic solid electrolyte (A) is preferably 50 mass % or more, more preferably 70 mass % or more, and particularly preferably 90 mass % or more with respect to 100 mass % of the solid component. In the same point of view, the upper limit of the concentration is preferably 99.9 mass % or less, more preferably 99.5 mass % or less, and particularly preferably 99 mass % or less.

In addition, the solid component in this specification refers to a component that does not disappear by volatilization or evaporation when a drying treatment is performed at 100° C. Typically, the solid component refers to a component other than a dispersion medium described below.

The inorganic solid electrolyte may be used singly or two or more types thereof may be used in combination.

(Binder Particles (B))

In the polymer forming the binder particle used in the invention, a repeating unit derived from a macromonomer (X) having a number average molecular weight of 1,000 or greater is incorporated as a side chain component.

Main Chain Component

The main chain of the polymer forming the binder particle (B) according to the invention is not particularly limited, and a well-known polymer component can be applied. As the monomer forming the main chain component, a monomer having a polymerizable unsaturated bond is preferable, and, for example, various vinyl-based monomers or acryl-based monomers can be applied. According to the invention, among these, an acryl-based monomer is preferably used. It is still more preferable that a monomer selected from a (meth)acrylic acid monomer, a (meth)acrylic acid ester monomer, and a (meth)acrylonitrile is preferably used. The number of polymerizable groups is not particularly limited, but is preferably 1 to 4.

The polymer forming the binder particle according to the invention preferably has at least one from the group of functional groups (b). This group of functional groups may be included in the main chain or may be included in the side chain described below, but it is preferable that the group of functional groups is included in the main chain. In this manner, a specific functional group is included in a main chain, an interaction with a hydrogen atom, an oxygen atom, or a sulfur atom which is considered to exist on the surface of a solid electrolyte, an active substance, a collector becomes strong, binding properties increase, and thus an effect of decreasing resistance in an interface can be expected.

Group of Functional Groups (b)

Carbonyl group, amino group, sulfonic acid group, phosphoric acid group, hydroxy group, ether group, cyano group, and thiol group

Examples of the carbonyl group-containing group include a carboxyl group, carbonyloxy group, and an amide group, and the number of carbon atoms is preferably 1 to 24, more preferably 1 to 12, and particularly preferably 1 to 6.

The amino group preferably has 0 to 12 carbon atoms, more preferably has 0 to 6 carbon atoms, and particularly preferably 0 to 2 carbon atoms.

The sulfonic acid group may be an ester or a salt thereof. In the case of an ester, the number of carbon atoms is preferably 1 to 24, more preferably 1 to 12, and particularly preferably 1 to 6.

The phosphoric acid group may be an ester or a salt thereof. In the case of an ester, the number of carbon atoms is preferably 1 to 24, more preferably 1 to 12, and particularly preferably 1 to 6.

In addition, the functional group may exist as a substituent and may exist as a linking group. For example, the amino group may exist as a bivalent imino group or a trivalent nitrogen atom.

The vinyl-based monomer that forms the polymer is preferably expressed by Formula (b-1) below.

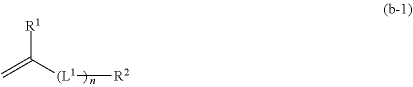

In the formula, R¹ represents a hydrogen atom, a hydroxy group, a cyano group, a halogen atom, and an alkyl group (the number of carbon atoms is preferably 1 to 24, more preferably 1 to 12, and particularly preferably 1 to 6), and alkenyl group (the number of carbon atoms is preferably 2 to 24, more preferably 2 to 12, and particularly preferably 2 to 6), an alkynyl group (the number of carbon atoms is preferably 2 to 24, more preferably 2 to 12, and particularly preferably 2 to 6), or an aryl group (the number of carbon atoms is preferably 6 to 22 and more preferably 6 to 14). Among these, a hydrogen atom or an alkyl group is preferable, and a hydrogen atom or a methyl group is more preferable.

R² represents a hydrogen atom, an alkyl group (the number of carbon atoms is preferably 1 to 24, more preferably 1 to 12, and particularly preferably 1 to 6), an alkenyl group (the number of carbon atoms is preferably 2 to 12 and more preferably 2 to 6), an aryl group (the number of carbon atoms is preferably 6 to 22 and more preferably 6 to 14), an aralkyl group (the number of carbon atoms is preferably 7 to 23 and more preferably 7 to 15), a cyano group, a carboxyl group, a hydroxy group, a thiol group, a sulfonic acid group, a phosphoric acid group, a phosphonic acid group, an aliphatic heterocyclic group containing an oxygen atom (the number of carbon atoms is preferably 2 to 12 and more preferably 2 to 6), or an amino group (NR^{N}₂:R^{N} is preferably a hydrogen atom or an alkyl group having 1 to 3 carbon atoms, as defined below). Among these, a methyl group, an ethyl group, a propyl group, a butyl group, a cyano group, an ethenyl group, a phenyl group, a carboxyl group, a thiol group, a sulfonic acid group, and the like are preferable.

R² may further include a substituent T described below. Among these, a carboxyl group, a halogen atom (a fluorine atom or the like), a hydroxy group, an alkyl group, and the like may be substituted.

A carboxyl group, a hydroxy group, a sulfonic acid group, a phosphoric acid group, and a phosphonic acid group may be esterified, for example, according to an alkyl group having 1 to 6 carbon atoms.

The aliphatic heterocyclic group containing an oxygen atom is preferably an epoxy group-containing group, an oxetane group-containing group, and a tetrahydrofuryl group-containing group, and the like.

L¹ is an arbitrary linking group, and examples thereof include examples of a linking group L described below. Specific examples thereof include an alkylene group having 1 to 6 (preferably 1 to 3) carbon atoms an alkenylene group having 2 to 6 (preferably 2 to 3) carbon atoms, an arylene group having 6 to 24 (preferably 6 to 10) carbon atoms, an oxygen atom, a sulfur atom, an imino group (NR^{N}), a carbonyl group, a phosphoric acid-linking group (—O—P(OH)(O)—O—), and a phosphonic acid-linking group (—P(OH)(O)—O—), or a group relating to the combination thereof. The linking group may have an arbitrary substituent. The number of linking atoms and a preferable range of the number of linking atom are also as described below. Examples of the arbitrary substituent include the substituent T, and examples thereof include an alkyl group or a halogen atom.

n is 0 or 1.

As the acryl-based monomer that forms the polymer, a monomer expressed by any one of Formulae (b-2) to (b-6) below, in addition to Formula (b-1) above is preferable.

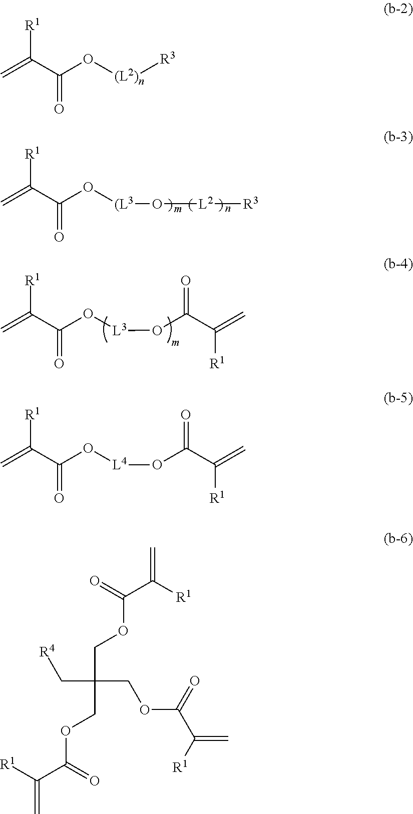

R¹ and n have the same meaning as in Formula (b-1) above.

R³ has the same meaning as R². However, preferable examples thereof include a hydrogen atom, an alkyl group, an aryl group, a carboxyl group, a thiol group, a phosphoric acid group, a phosphonic acid group, an aliphatic heterocyclic group containing an oxygen atom, and an amino group (NR^{N}₂).

L² is an arbitrary linking group, and examples of L² are preferably examples of L¹ and more preferably an oxygen atom, an alkylene group having 1 to 6 (preferably 1 to 3) carbon atoms, an alkenylene group having 2 to 6 (preferably 2 to 3) carbon atoms, a carbonyl group, an imino group (NR^{N}), or a group relating to the combination thereof.

L³ is a linking group, and examples of L³ is preferably examples of L² and more preferably an alkylene group having 1 to 6 (preferably 1 to 3) carbon atoms.

L⁴ has the same meaning as L¹.

R⁴ is a hydrogen atom, an alkyl group having 1 to 6 (preferably 1 to 3) carbon atoms, an hydroxy group-containing group having 0 to 6 (preferably 0 to 3) carbon atoms, a carboxyl group-containing group having 0 to 6 (preferably 0 to 3) carbon atoms, or a (meth)acryloyloxy group. In addition, R⁴ is a linking group of L¹ described above and may form a dimer in a portion thereof

m represents an integer of 1 to 200, and m is preferably an integer of 1 to 100 and more preferably an integer of 1 to 50.

In Formulae (b-1) to (b-6) above, with respect to a group having a substituent such as an alkyl group, an aryl group, an alkylene group, or an arylene group, the group may have an arbitrary substituent as long as an effect of the invention is maintained. Examples of the arbitrary substituent include the substituent T, and specifically, an arbitrary substituent such as a halogen atom, a hydroxy group, a carboxyl group, a thiol group, an acyl group, an acyloxy group, an alkoxy group, an aryloxy group, an aryloyl group, an aryloyloxy group, and an amino group may be included.

Hereinafter, examples of the monomer making a main chain of the polymer forming the binder particle are provided below, but the invention is not intended to be construed to be limited thereto. n in the formulae below represents 1 to 1,000,000.

<Specific Examples of Monomers>

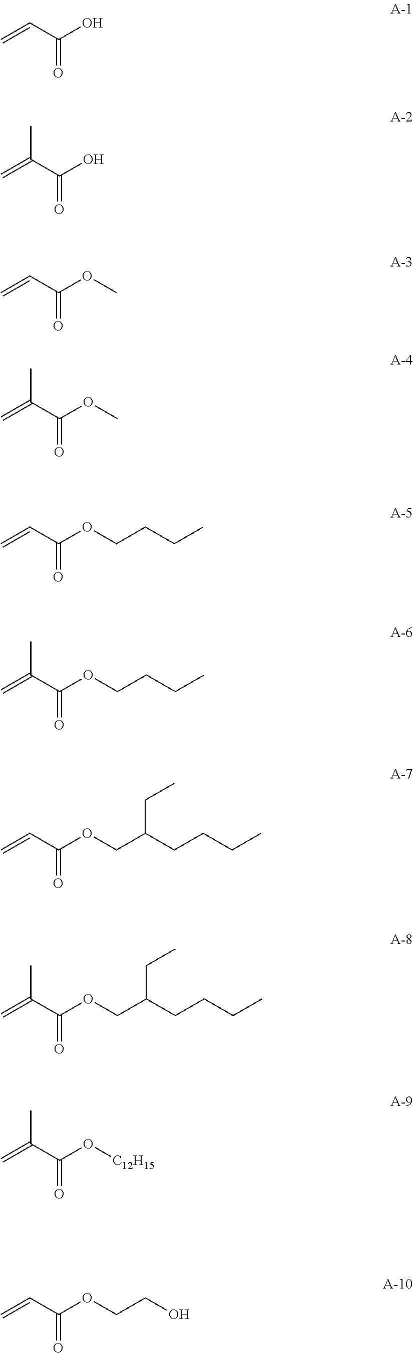

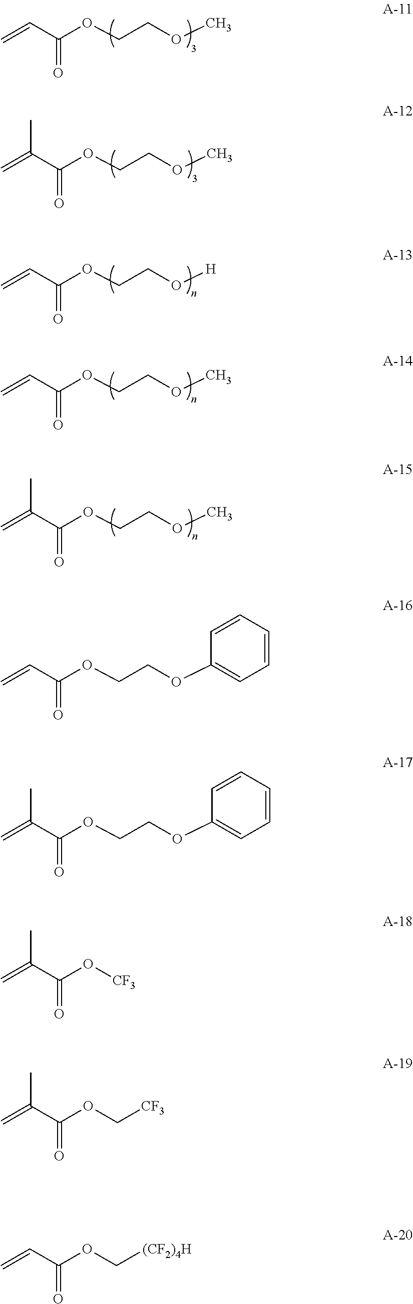

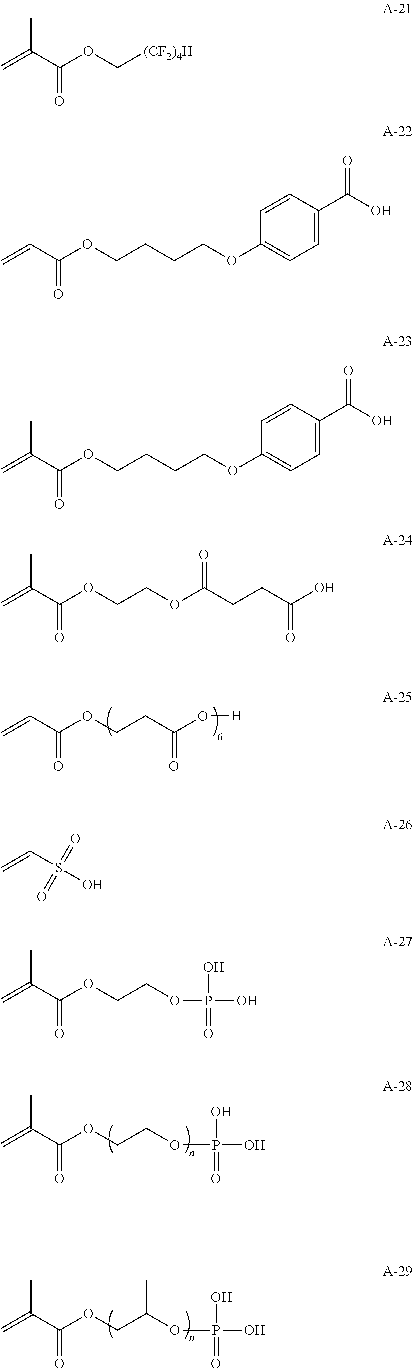

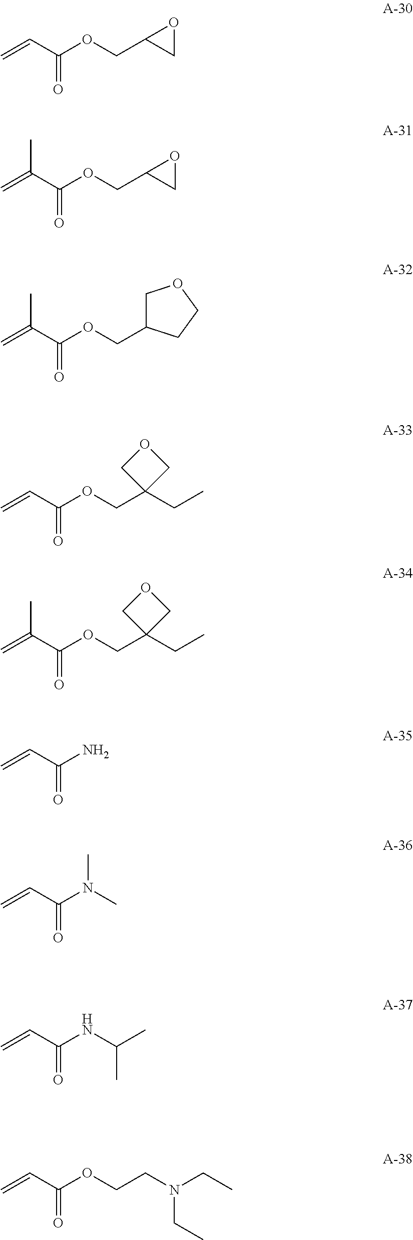

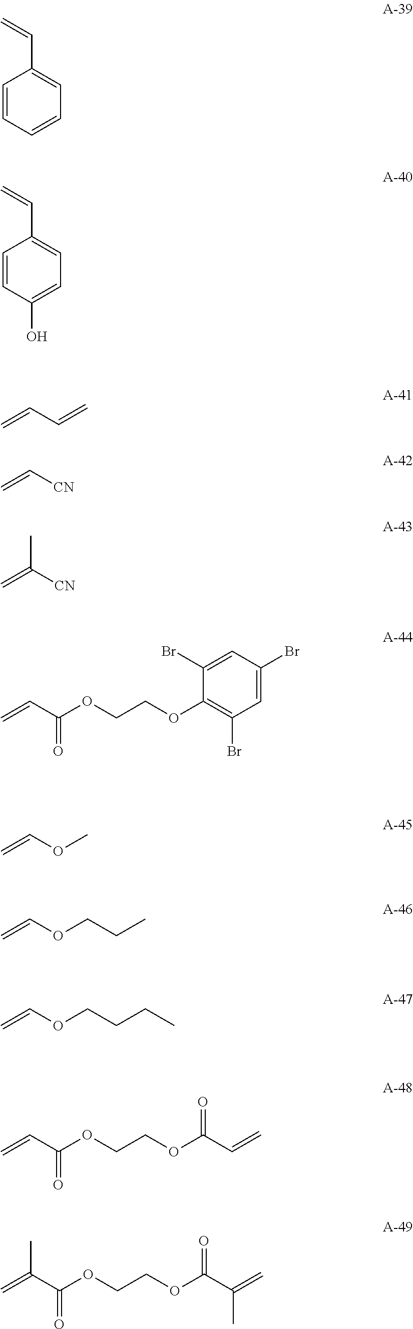

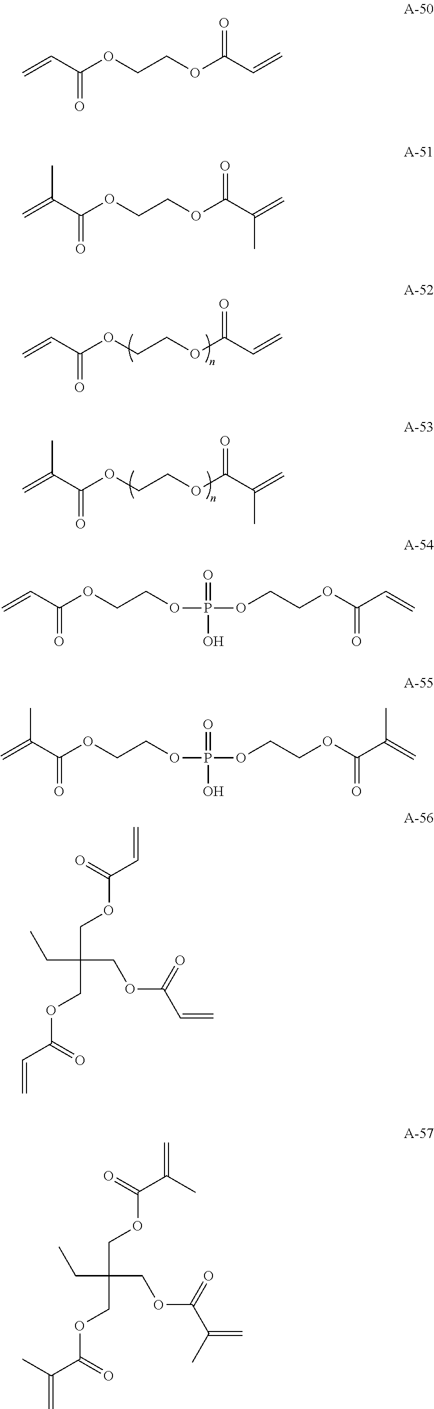

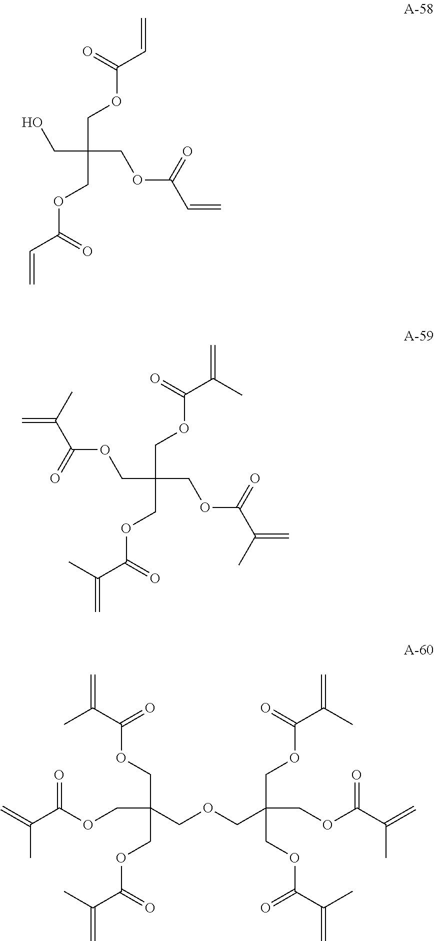

Side Chain Component (Macromonomer (X))

The number average molecular weight of the macromonomer is 1,000 or greater, more preferably 2,000 or greater, and particularly preferably 3,000 or greater. The upper limit thereof is preferably 500,000 or less, more preferably 100,000 or less, and particularly preferably 30,000 or less. If the polymer forming the binder particle has a side chain having the molecular weight in the range described above, the polymer can be evenly dispersed in the organic dissolving agent in a more satisfactory manner and can be mixed with the solid electrolyte particle to be applied.

Herein, if an action of the solid electrolyte composition according to the preferable embodiment of the invention is described, it is considered that the side chain component in the binder polymer has a function of improving dispersibility to the dissolving agent. In this manner, since the binder is satisfactorily dispersed in the dissolving agent in a particle state, the solid electrolyte can be fixed without being partially or entirely applied. As a result, even intervals between binder particles are maintained, electric connection between particles is not blocked, and thus it is considered that an increase in interface resistance between solid particles, between collectors, and the like is prevented. Further, if the binder polymer has a side chain, not only an effect that the binder particles are attached to the solid electrolyte particle but also an effect that the side chains thereof are twisted can be expected. Accordingly, it is considered that compatibility between the suppression of interface resistance relating to the solid electrolyte and the improvement of the adhesiveness can be achieved. Further, since dispersibility thereof is good, a step of inverting phases in the organic dissolving agent can be omitted compared with emulsion polymerization in water or the like, and a dissolving agent having a boiling point can be used as a dispersion medium. In addition, the molecular weight of the side chain component (X) can be identified by measuring a molecular weight of the polymerizable compound (macromonomer) that is combined when the polymer included in the binder particles (B) is synthesized.

—Measuring of Molecular Weight—

Unless otherwise described, the molecular weight of the polymer according to the invention refers to a number average molecular weight, the number average molecular weight in terms of standard polystyrene is calculated by the gel permeation chromatography (GPC). In the measuring method, a value measured by the method of Condition 1 or 2 (priority) below is basically used. However, depending on the polymer type, an appropriate or proper eluent is chosen to be used.

(Condition 1)

Column: Two items of TOSOH TSKgel Super AWM-H are connected.

Carrier: 10 mM LiBr/N-methyl pyrrolidone

Measuring temperature: 40° C.

Carrier flow rate: 1.0 ml/min

Specimen concentration: 0.1 mass %

Detector: Refractive Index (RI) detector

(Condition 2)

Column: A column obtained by connecting TOSOH TSKgel Super HZM-H, TOSOH TSKgel Super HZ4000, and TOSOH TSKgel Super HZ2000 is used.

Carrier: Tetrahydrofuran

Measuring temperature: 40° C.

Carrier flow rate: 1.0 ml/min

Specimen concentration: 0.1 mass %

Detector: Refractive Index (RI) detector

The SP value of the macromonomer (X) is preferably 10 or less and more preferably 9.5 or less. The lower limit thereof is not particularly limited, but it is practical that the lower limit thereof is 5 or greater.

—Definition of SP Value—

Unless described otherwise, the SP value in this specification is obtained by the Hoy method (H. L. Hoy Journal of Painting, 1970, Vol. 42, 76 to 118). In addition, with respect to the SP value, the unit thereof is omitted, but the unit thereof is cal^{1/2} cm^{-3/2}. The SP value of the side chain component (X) is almost the same as the SP value of the raw material monomer making the side chain, and thus the SP value of the side chain component (X) may be evaluated by the SP value of the raw material monomer.

The SP value may be an index indicating characteristics of being dispersed in an organic dissolving agent. Here, it is preferable that the side chain component is included in a specific molecular weight or greater and preferably in the SP value or greater, since binding properties with the solid electrolyte are enhanced, and accordingly, affinity with a solvent increases, such that the side chain component can be stably dispersed.

The main chain of the side chain component of the macromonomer (X) is not particularly limited, and a general polymer component can be applied. The macromonomer (X) preferably has a polymerizable unsaturated bond and may include, for example, various vinyl groups or (meth)acryloyl groups. According to the invention, among these, it is preferable that the macromonomer (X) has a (meth)acryloyl group.

In addition, in this specification, the expression “acryl” or “acryloyl” widely indicates not only an acryloyl group but also a group including a derivation structure thereof, and a structure having a specific substituent in an a position of an acryloyl group is included. However, in a narrow sense, a case where a hydrogen atom is in an a position is called acryl or acryloyl. A case where a methyl group is in an a position is called methacryl, and any one of acryl (a hydrogen atom in an a position) and methacryl (a methyl group in an a position) may be called as (meth)acryl or the like.

The macromonomer (X) preferably includes a repeating unit derived from a monomer selected from a (meth)acrylic acid monomer, a (meth)acrylic acid ester monomer, and (meth)acrylonitrile. In addition, the macromonomer (X) preferably includes a polymerizable double bond and a straight chain hydrocarbon structure unit having 6 or more carbon atoms (preferably an alkylene group having 6 to 30 carbon atoms and more preferably an alkylene group having 8 to 24 carbon atoms). In this manner, if the macromonomer making a side chain has a straight chain hydrocarbon structure unit S, affinity with a solvent increases and thus an effect of increasing dispersion stability can be expected.

The macromonomer (X) preferably has a portion expressed by Formula (b-11) below.

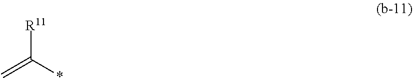

R¹¹ has the same meaning as R¹. * is a bonding portion.

The macromonomer (X) preferably has a portion expressed by Formulae (b-12a) to (b-12c) below. Hereinafter, this portion may be referred to as a “specific polymerizable portion”.

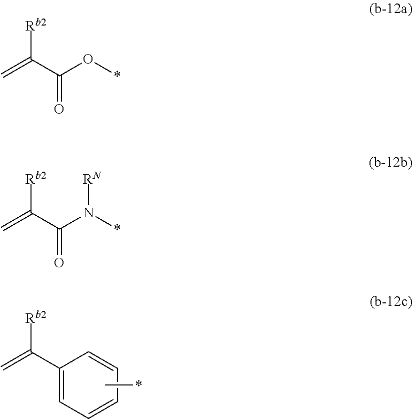

R^{b2} has the same meaning as R¹. * is a bonding portion. R^{N} has the same meaning as the definition indicated by the substituent T below. An arbitrary substituent T may be substituted with a benzene ring of Formulae (b-12c), (b-13c), and (b-14c).

The structural portion existing at an end of the bonding portion of * is not particularly limited, as long as a molecular weight as a macromonomer is satisfied, but the structural portion is preferably a structural portion formed of a carbon atom, an oxygen atom, and a hydrogen atom. At this point, the structural portion may have the substituent T and may include a halogen atom (fluorine atom).

The macromonomer (X) is preferably a compound expressed by Formulae (b-13a) to (b-13c) below or a compound having a repeating unit expressed by Formulae (b-14a) to (b-14c).

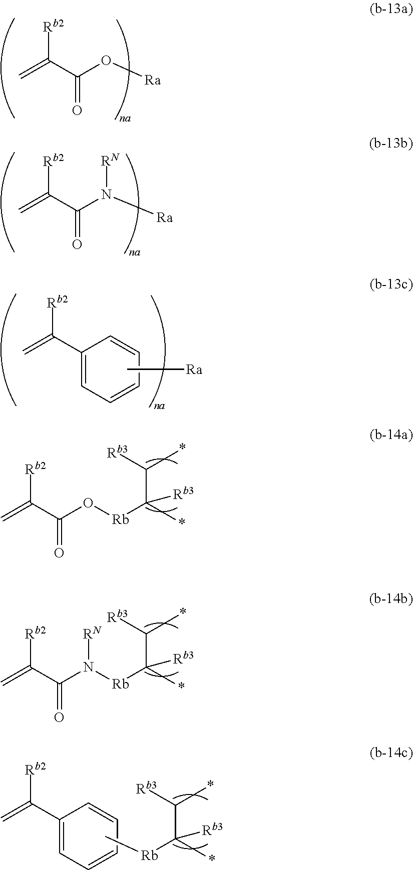

R^{b2} and R^{b3} have the same meaning as R¹.

na is not particularly limited, but na is preferably an integer of 1 to 6 or more preferably 1 or 2.

Ra represents a substituent (preferably an organic group) when na is 1 and represents a linking group when na is 2 or greater.

Rb is a bivalent linking group.

When Ra and Rb are linking groups, examples of the linking group include the linking group L below. Specifically, an alkane linking group having 1 to 30 carbon atoms (an alkylene group, if the linking group is bivalent), a cycloalkane linking group having 3 to 12 carbon atoms (a cycloalkylene group, if the linking group is bivalent), an aryl linking group having 6 to 24 carbon atoms (an arylene group, if the linking group is bivalent), a heteroaryl linking group having 3 to 12 carbon atoms (a heteroarylene group, if the linking group is bivalent), an ether group (—O—), a sulfide group (—S—), a phosphinidene group (—PR—: R is a hydrogen atom or an alkyl group having 1 to 6 carbon atoms), a silylene group (—SiRR′—: R and R′ are hydrogen atoms or alkyl groups having 1 to 6 carbon atoms), a carbonyl group, an imino group (—NR^{N}—: R^{N} follows a definition described below and, herein, is preferably a hydrogen atom, an alkyl group having 1 to 6 carbon atoms, and an aryl group having 6 to 10 carbon atoms), or a combination thereof. Among these, an alkane linking group having 1 to 30 carbon atoms (an alkylene group, if the linking group is bivalent), an aryl linking group having 6 to 24 carbon atoms (an arylene group, if the linking group is bivalent), an ether group, a carbonyl group, and a combination thereof are preferable.

The linking group forming Ra and Rb is preferably a linking structure formed of a carbon atom, an oxygen atom, and a hydrogen atom. Otherwise, the linking group forming Ra and Rb is preferably a structural portion having the repeating unit (b-15) below. The number of atoms forming a linking group when Ra and Rb are linking groups or the number of linking atoms has the same as the linking group L.

If Ra is a univalent substituent, examples of Ra include examples of the substituent T described below. Among them, an alkyl group, an alkenyl group, and an aryl group are preferable. At this point, the substituent may be substituted with the linking group L inserted between the substituent and the linking group L or the linking group L may be inserted between the substituents.

Otherwise, if Ra is a univalent substituent, Ra is preferably a structure of —Rb—Rc or a structural portion having the repeating unit (b-15) below. Here, examples of Rc include examples of the substituent T described below. Among them, an alkyl group, an alkenyl group, and an aryl group are preferable.

At this point, each of Ra and Rb preferably contains a straight chain hydrocarbon structure unit having 1 to 30 carbon atoms (preferably an alkylene group), and each of Ra and Rb more preferably includes the straight chain hydrocarbon structure unit S. In addition, each of Ra to Rc described above may have a linking group or a substituent, and examples thereof include the linking group L or the substituent T described below.

The macromonomer (X) preferably has a repeating unit expressed by Formula (b-15) below.

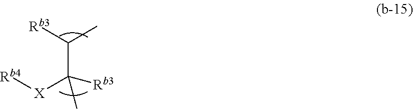

In the formula, R^{b4} is a hydrogen atom or the substituent T described below. R^{b4} is preferably a hydrogen atom, an alkyl group, an alkenyl group, and an aryl group. When R^{b4} is an alkyl group, an alkenyl group, and an aryl group and further has the substituent T described below, and may have, for example, a halogen atom or a hydroxy group.

X is a linking group and examples thereof include examples of the linking group L. X is preferably an ether group, a carbonyl group, an imino group, an alkylene group, an arylene group, or a combination thereof. Specific examples of the linking group relating to the combination include a linking group formed of a carbonyloxy group, an amide group, an oxygen atom, a carbon atom, and a hydrogen atom. A preferable number of carbon atoms when R^{b4} and X include carbon is the same as that of the substituent T or the linking group L. A preferable number of atoms formed of the linking group and a preferable number of the linking atoms are the same as those of the substituent T or the linking group L.

In addition, examples of the macromonomer (X) include a (meth)acrylate constituent unit such as Formula (b-15) above and an alkylene chain (for example, an ethylene chain) that may have a halogen atom (for example, a fluorine atom), in addition to the repeating unit having the polymerizable group described above. At this point, an alkylene chain may be inserted between the ether groups (O) or the like.

The substituent may have a structure in which an arbitrary substituent is disposed in the terminal of the linking group, and examples of the terminal substituent include the substituent T below, and the examples of R¹ described above are preferable.

In addition, with respect to the indication of the compound in the specification (for example, when a compound is attached at the foot of the indication), the indication is meant to include not only the compound but also a salt thereof and an ion thereof. In addition, the indication is meant to include a derivative in which a portion is changed such as a case where a substituent is introduced in the range in which a desired effect is achieved.

A substituent in which substitution or non-substitution is not indicated in this specification (in the same manner as in the linking group) means having an arbitrary substituent in the group. The meaning is the same as in the compound in which substitution or non-substitution is not indicated. Examples of the preferable substituent include the substituent T below.

Examples of the substituent T include the followings.

Examples thereof include an alkyl group (preferably an alkyl group having 1 to 20 carbon atoms, for example, methyl, ethyl, isopropyl, t-butyl, pentyl, heptyl, 1-ethylpentyl, benzyl, 2-ethoxyethyl, and 1-carboxymethyl), an alkenyl group (preferably an alkenyl group having 2 to 20 carbon atoms, for example, vinyl, allyl, and oleyl), an alkynyl group (preferably an alkynyl group having 2 to 20 carbon atoms, for example, ethynyl, butadienyl, and phenylethynyl), a cycloalkyl group (preferably a cycloalkyl group having 3 to 20 carbon atoms, for example, cyclopropyl, cyclopentyl, cyclohexyl, and 4-methylcyclohexyl), an aryl group (preferably an aryl group having 6 to 26 carbon atoms, for example, phenyl, 1-naphthyl, 4-methoxyphenyl, 2-chlorophenyl, and 3-methylphenyl), a hetero cyclic group (preferably a hetero cyclic group having 2 to 20 carbon atoms, a hetero cyclic group of 5 or 6-membered ring having at least one of an oxygen atom, a sulfur atom, and a nitrogen atom is preferable, for example, tetrahydropyran, tetrahydrofuran, 2-pyridyl, 4-pyridyl, 2-imidazolyl, 2-benzimidazolyl, 2-thiazolyl, and 2-oxazolyl), an alkoxy group (preferably an alkoxy group having 1 to 20 carbon atoms, for example, methoxy, ethoxy, isopropyloxy, and benzyloxy), an aryloxy group (preferably an aryloxy group having 6 to 26 carbon atoms, for example, phenoxy, 1-naphthyloxy, 3-methylphenoxy, and 4-methoxyphenoxy), an alkoxycarbonyl group (preferably an alkoxycarbonyl group having 2 to 20 carbon atoms, for example, ethoxycarbonyl and 2-ethylhexyloxycarbonyl), an aryloxycarbonyl group (preferably an aryloxycarbonyl group having 6 to 26 carbon atoms, for example, phenoxycarbonyl, 1-naphthyloxycarbonyl, 3-methylphenoxycarbonyl, and 4-methoxyphenoxycarbonyl), an amino group (preferably an amino group having 0 to 20 carbon atoms, examples thereof include an alkylamino group and an arylamino group, for example, amino, N,N-dimethylamino, N,N-diethylamino, N-ethylamino, and anilino), a sulfamoyl group (preferably a sulfamoyl group having 0 to 20 carbon atoms, for example, N,N-dimethylsulfamoyl and N-phenylsulfamoyl), an acyl group (preferably an acyl group having 1 to 20 carbon atoms, for example, acetyl, propionyl, and butyryl), an aryloyl group (preferably an aryloyl group having 7 to 23 carbon atoms, for example, benzoyl), an acyloxy group (preferably an acyloxy group having 1 to 20 carbon atoms, for example, acetyloxy), an aryloyloxy group (preferably an aryloyloxy group having 7 to 23 carbon atoms, for example, benzoyloxy), a carbamoyl group (preferably a carbamoyl group having 1 to 20 carbon atoms, for example, N,N-dimethylcarbamoyl and N-phenylcarbamoyl), an acylamino group (preferably an acylamino group having 1 to 20 carbon atoms, for example, acetylamino, and benzoylamino), an alkylthio group (preferably an alkylthio group having 1 to 20 carbon atoms, for example, methylthio, ethylthio, isopropylthio, and benzylthio), an arylthio group (preferably an arylthio group having 6 to 26 carbon atoms, for example, phenylthio, 1-naphthylthio, 3-methylphenylthio, and 4-methoxyphenylthio), alkyl sulfonyl group (preferably an alkylsulfonyl group having 1 to 20 carbon atoms, for example, methylsulfonyl and ethylsulfonyl), an arylsulfonyl group (preferably an arylsulfonyl group having 6 to 22 carbon atoms, for example, benzenesulfonyl), an alkylsilyl group (preferably an alkylsilyl group having 1 to 20 carbon atoms, for example, monomethylsilyl, dimethylsilyl, trimethylsilyl, and triethylsilyl), an arylsilyl group (preferably an arylsilyl group having 6 to 42 carbon atoms, for example, triphenylsilyl), a phosphoryl group (preferably a phosphoryl group having 0 to 20 carbon atoms, for example, —OP(═O)(R^{P})₂), a phosphonyl group (preferably a phosphonyl group having 0 to 20 carbon atoms, for example, —P(═O)(R^{P})₂), a phosphinyl group (preferably a phosphinyl group having 0 to 20 carbon atoms, for example, —P(R^{P})₂), a (meth)acryloyl group, a (meth)acryloyloxy group, a hydroxyl group, a cyano group, and a halogen atom (for example, a fluorine atom, a chlorine atom, a bromine atom, and an iodine atom).

In addition, the substituent T may be further substituted with each of these groups exemplified as the substituent T.

If the compound and the substituent•the linking group, or the like include an alkyl group•an alkylene group, an alkenyl group•an alkenylene group, an alkynyl group•an alkynylene group, or the like, these may have a cyclic or shape or a straight chain shape and may be substituted or non-substituted as described above.

The respective substituents defined in this specification may be substituted with the linking group L inserted therebetween or the linking group L may be inserted in the structure, in the range in which the effect of the invention is achieved. For example, an alkyl group•an alkylene group, an alkenyl group•an alkenylene group, or the like may have a hetero linking group be inserted therebetween, in the structure thereof.

As the linking group L, a hydrocarbon linking group [an alkylene group having 1 to 10 carbon atoms (more preferably having 1 to 6 carbon atoms and still more preferably having 1 to 3 carbon atoms), an alkenylene group having 2 to 10 carbon atoms (more preferably having 2 to 6 carbon atoms and still more preferably having 2 to 4 carbon atoms), an alkynylene group having 2 to 10 carbon atoms (more preferably having 2 to 6 carbon atoms and still more preferably having 2 to 4 carbon atoms), or an arylene group having 6 to 22 carbon atoms (more preferably having 6 to 10 carbon atoms)], a hetero linking group [a carbonyl group (—CO—), a thiocarbonyl group (—CS—), an ether group (—O—), a thioether group (—S—), an imino group (—NR^{N}—), an imine linking group (R^{N}—N═C< and —N═C(R^{N})—), a sulfonyl group (—SO₂—), a sulfonyl group (—SO—), a phosphoric acid-linking group (—O—P(OH)(O)—O—), or phosphonic acid-linking group (—P(OH)(O)—O—)], or a linking group obtained by linking these groups are preferable. In addition, if a ring is formed by condensation, the hydrocarbon linking group may be linked by appropriately forming a double bond or a triple bond. As the formed ring, a 5-membered ring or a 6-membered ring is preferable. As the 5-membered ring, a nitrogen-containing 5-membered ring is preferable, and examples of the compound forming the ring include pyrrole, imidazole, pyrazole, indazole, indole, benzimidazole, pyrrolidine, imidazolidine, pyrazolidine, indoline, carbazole, and a derivative thereof. Examples of the 6-membered ring include piperidine, morpholine, piperazine, and a derivative thereof. In addition, when an aryl group, a hetero cyclic group, or the like is included, these may be a single ring or a condensed ring. In the same manner, these may be substituted or non-substituted.

R^{N} is a hydrogen atom or a substituent. As the substituent, an alkyl group (preferably having 1 to 24 carbon atoms, more preferably having 1 to 12, still more preferably having 1 to 6 carbon atoms, and particularly preferably having 1 to 3 carbon atoms), an alkenyl group (preferably having 2 to 24 carbon atoms, more preferably having 2 to 12 carbon atoms, still more preferably having 2 to 6 carbon atoms, and particularly preferably having 2 to 3 carbon atoms), an alkynyl group (preferably having 2 to 24 carbon atoms, more preferably having 2 to 12 carbon atoms, still more preferably having 2 to 6 carbon atoms, and particularly preferably having 2 to 3 carbon atoms), an aralkyl group (preferably having 7 to 22 carbon atoms, more preferably having 7 to 14 carbon atoms, and particularly preferably 7 to 10 carbon atoms), and an aryl group (preferably having 6 to 22 carbon atoms, more preferably having 6 to 14 carbon atoms, and particularly preferably having 6 to 10 carbon atoms) are preferable.

R^{P} is a hydrogen atom, a hydroxyl group, or a substituent. As the substituent, an alkyl group (preferably having 1 to 24 carbon atoms, more preferably having 1 to 12 carbon atoms, still more preferably having 1 to 6 carbon atoms, and particularly preferably having 1 to 3 carbon atoms), an alkenyl group (preferably having 2 to 24 carbon atoms, more preferably having 2 to 12 carbon atoms, still more preferably having 2 to 6 carbon atoms, and particularly preferably having 2 to 3 carbon atoms), an alkynyl group (preferably having 2 to 24 carbon atoms, more preferably having 2 to 12 carbon atoms, still more preferably having 2 to 6 carbon atoms, and particularly preferably having 2 to 3 carbon atoms), an aralkyl group (preferably having 7 to 22 carbon atoms, more preferably having 7 to 14 carbon atoms, and particularly preferably having 7 to 10 carbon atoms), an aryl group (preferably having 6 to 22 carbon atoms, more preferably having 6 to 14 carbon atoms, and particularly preferably having 6 to 10 carbon atoms), an alkoxy group (preferably having 1 to 24 carbon atoms, more preferably having 1 to 12 carbon atoms, still more preferably having 1 to 6 carbon atoms, and particularly preferably having 1 to 3 carbon atoms), an alkenyloxy group (preferably having 2 to 24 carbon atoms, more preferably having 2 to 12 carbon atoms, still more preferably having 2 to 6 carbon atoms, and particularly preferably having 2 to 3 carbon atoms), an alkynyloxy group (preferably having 2 to 24 carbon atoms, more preferably having 2 to 12 carbon atoms, still more preferably having 2 to 6 carbon atoms, and particularly preferably having 2 to 3 carbon atoms), an aralkyloxy group (preferably having 7 to 22 carbon atoms, more preferably having 7 to 14 carbon atoms, and particularly preferably having 7 to 10 carbon atoms), and an aryloxy group (preferably having 6 to 22 carbon atoms, more preferably having 6 to 14 carbon atoms, and particularly preferably having 6 to 10 carbon atoms) are preferable.

In this specification, the number of atoms forming a linking group is preferably 1 to 36, more preferably 1 to 24, still more preferably 1 to 12, and particularly preferably 1 to 6. The number of linking atoms of the linking group is preferably 10 or less and more preferably 8 or less. The lower limit is 1 or greater. The number of the linking atoms refers to a minimum number of atoms that are positioned in a course connecting predetermined structural portions to be related to the linking. For example, in the case of —CH₂—C(═O)—O—, the number of atoms forming the linking group is 6, but the number of linking atoms becomes 3.

Specifically, examples of the combination of the linking groups include the followings. Examples are an oxycarbonyl group (—OCO—), a carbonate group (—OCOO—), an amide group (—CONH—), an urethane group (—NHCOO—), an urea group (—NHCONH—), a (poly)alkyleneoxy group (-(Lr—O)x-), a carbonyl(poly)oxyalkylene group (—CO—(O—Lr)x-, a carbonyl(poly)alkyleneoxy group (—CO-(Lr—O)x-), a carbonyloxy(poly)alkyleneoxy group (—OCO-(Lr—O)x-), a (poly)alkyleneimino group (-(Lr—NR^{N})x), an alkylene(poly)iminoalkylene group (—Lr—(NR^{N}—Lr)x-), a carbonyl(poly)iminoalkylene group (—CO—(NR^{N}—Lr)x-), a carbonyl(poly)alkyleneimino group (—CO-(Lr—NR^{N})x-), a (poly)ester group (—(CO—O—Lr)x-, —(O—CO—Lr)x-, —(O—Lr—CO)x-, -(Lr—CO—O)x-, -(Lr—O—CO)x-), and a (poly)amide group (—(CO—NR^{N}—Lr)x-, —(NR^{N}—CO—Lr)x-, —(NR^{N}—Lr—CO)x-, -(Lr—CO—NR^{N})x-, and -(Lr—NR^{N}—CO)x-). x is an integer of 1 or greater, preferably 1 to 500, and more preferably 1 to 100.

Lr is preferably an alkylene group, an alkenylene group, and an alkynylene group. The number of carbon atoms of Lr is preferably 1 to 12, more preferably 1 to 6, and particularly preferably 1 to 3. Plural Lr's or R^{N}'s, R^{e}'s, or x's do not have to be identical to each other. The direction of the linking group is not limited to the description above, and may be understood to be a direction appropriately matched with a predetermined chemical formula.

As the macromonomer, a macromonomer having an ethylenically unsaturated bond in a terminal may be used. Here, the macromonomer is formed of a polymer chain portion and a portion of a polymerizable functional group having an ethylenically unsaturated double bond.

The copolymerization ratio of the repeating unit derived from the macromonomer (X) is not particularly limited, but the copolymerization ratio is preferably 1 mass % or greater, more preferably 3 mass % or greater, and particularly preferably 5 mass % or greater in the polymer forming binder particles. The upper limit is preferably 50 mass % or less, more preferably 30 mass % or less, and particularly preferably 20 mass % or less.

Various Elements of Binder Particles

The number average molecular weight of the polymer included in the binder particles (B) is preferably 5,000 or greater, more preferably 10,000 or greater, and particularly preferably 30,000 or greater. The upper limit is preferably 1,000,000 or less and more preferably 200,000 or less.

The blending amount of the binder particles (B) is preferably 0.1 parts by mass or greater, more preferably 0.3 parts by mass or greater, and particularly preferably 1 parts by mass or greater with respect to 100 parts by mass of the solid electrolyte (including an active substance, if used). The upper limit is preferably 20 parts by mass or less, more preferably 10 parts by mass or less, and particularly preferably 5 parts by mass or less.

With respect to the solid electrolyte composition, the content of the binder particle is preferably 0.1 mass % or greater, more preferably 0.3 mass % or greater, and particularly preferably 1 mass % or greater in the solid component. The upper limit thereof is preferably 20 mass % or less, more preferably 10 mass % or less, and particularly preferably 5 mass % or less.

If the binder particles are used in the range described above, compatibility between the adherence of the solid electrolyte and the suppression of the interface resistance can be more effectively realized.

The binder particles (B) may be used singly or two or more types thereof may be used in combination. In addition, the binder particles (B) may be used in combination with other particles.

According to the invention, the average diameter of the binder particles is important, is set to be 1,000 nm or shorter, and is preferably 750 nm or shorter, more preferably 500 nm or shorter, still more preferably 300 nm or shorter, and particularly preferably 200 nm or shorter. The lower limit thereof is set to be 10 nm or longer, and is preferably 20 nm or longer, more preferably 30 nm or longer, and particularly preferably 50 nm or longer. The average diameter of the binder particles according to the invention is under the condition measured in the measuring of the average diameter of the binder in the section of examples below, unless described otherwise.

When the solid electrolyte is in a particle state, the particle diameter of the binder particle is preferably shorter than the average diameter of the solid electrolyte.

If the size of the binder particle is caused to be in the range described above, the satisfactory adherence and the satisfactory suppression of the interface resistance can be realized.

In addition, the created all-solid-state secondary battery can be measured, for example, by disassembling a battery, peeling off electrodes, and measuring electrode materials in conformity with the method of measuring a particle diameter of the binder described below, and removing a measured value of the particle diameter of particles other than the binder measured in advance.

The polymer forming binder particles according to the invention is preferably amorphous. According to the invention, the expression that a polymer is “amorphous” typically indicates that a polymer an endothermic peak is not seen caused by crystal fusion when a glass transition temperature of the polymer is measured in a Tg measuring method described below. The glass transition temperature (Tg) of the polymer is preferably 50° C. or lower, more preferably 30° C. or lower, still more preferably 20° C. or lower, and particularly preferably 0° C. or lower. The lower limit thereof is preferably −80° C. or higher, more preferably −70° C. or higher, and particularly preferably −60° C. or higher. The glass transition temperature of the polymer making the binder particles according to the invention conforms to the condition measured in the glass transition temperature of the polymer indicated by the section of the examples below, unless described otherwise.

In addition, the created all-solid-state secondary battery is measured, for example, by disassembling a battery, inputting electrodes into water, dispersing the materials thereof, performing filtration, collecting remaining solids, and measuring a glass transition temperature in a Tg measuring method described below.

The binder particles (B) may be made of only a polymer for forming this or may be formed in a state in which other types of materials (polymers, low molecular compounds, inorganic compounds, or the like) are included. Preferably, the binder particles (B) are binder particles made of only a constituent polymer.

(Dispersion Medium (C))

In the solid electrolyte composition according to the invention, a dispersion medium in which respective components are dispersed may be used. Examples of the dispersion medium include an aqueous organic solvent. Examples thereof include an alcohol compound solvent such as methylalcohol, ethylalcohol, 1-propylalcohol, 2-propylalcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol and an ether compound solvent including alkylene glycol alkyl ether (ethylene glycol monomethyl ether, ethylene glycol monobutyl ether, diethylene glycol, dipropylene glycol, propylene glycol monomethyl ether, diethylene glycol monomethyl ether, triethylene glycol, polyethylene glycol, dipropylene glycol monomethyl ether, tripropylene glycol monomethyl ether, diethylene glycol monobutyl ether, diethylene glycol monobutyl ether, or the like).

Examples of the amide compound solvent include N,N-dimethylformamide, 1-methyl-2-pyrrolidone, 2-pyrrolidinone, 1,3-dimethyl-2-imidazolidinone, ε-caprolactam, formamide, N-methylformamide, acetamide, N-methylacetamide, N,N-dimethylacetamide, N-methylpropanamide, and hexamethylphosphorictriamide.

Examples of the ketone compound solvent include acetone, methylethylketone, methylisobutylketone, and cyclohexanone.

Examples of the ether compound solvent include dimethyl ether, diethyl ether, and tetrahydrofuran.

Examples of the aromatic compound solvent include benzene and toluene.

Examples of the aliphatic compound solvent include hexane and heptane.

Examples of the nitrile compound solvent include acetonitrile.

According to the invention, among them, an ether compound solvent, a ketone compound solvent, an aromatic compound solvent, or an aliphatic compound solvent is preferably used. A boiling point of the dispersion medium at normal pressure (1 atmosphere) is preferably 50° C. or higher and more preferably 80° C. or higher. The upper limit is preferably 250° C. or lower and still more preferably 220° C. or lower. The dispersion medium may be used singly or two or more types thereof may be used in combination.

According to the invention, the amount of the dispersion medium in the solid electrolyte composition may be an arbitrary amount for the balance between the solid electrolyte composition and the drying load. Generally, in the solid electrolyte composition, the amount of the dispersion medium is preferably 20 mass % to 99 mass %.

(Supporting Electrolyte [Lithium Salt and the Like] (D))

As the supporting electrolyte (lithium salt and the like) that can be used in the invention, a lithium salt that is used in a product of this type is preferable, and the type of the lithium salt is not particularly limited, but lithium salts described below are preferable.

(L-1) Inorganic lithium salt: An inorganic fluoride salt such as LiPF₆, LiBF₄, LiAsF₆, and LiSbF₆; a perhalogen acid salt such as LiClO₄, LiBrO₄, and LiIO₄; an inorganic chloride salt such as LiAlCl₄; and the like.

(L-2) Fluorine-containing organic lithium salt: a perfluoroalkane sulfonic acid salt such as LiCF₃SO₃; a perfluoroalkane sulfonylimide salt such as LiN(CF₃SO₂)₂, LiN(CF₃CF₂SO₂)₂, LiN(FSO₂)₂, and LiN(CF₃SO₂)(C₄F₉SO₂); a perfluoroalkane sulfonylmethide salt such as LiC(CF₃SO₂)₃; a fluoroalkyl fluoride phosphoric acid salt such as Li[PF₅(CF₂CF₂CF₃)], Li[PF₄(CF₂CF₂CF₃)₂], Li[PF₃(CF₂CF₂CF₃)₃], Li[PF₅(CF₂CF₂CF₂CF₃)], Li[PF₄(CF₂CF₂CF₂CF₃)₂], and Li[PF₃(CF₂CF₂CF₂CF₃)₃]; and the like.

(L-3) Oxalatoborate salt: lithium bis(oxalato)borate, lithium difluorooxalatoborate, and the like.

Among these, LiPF₆, LiBF₄, LiAsF₆, LiSbF₆, LiClO₄, Li(Rf¹SO₃), LiN(Rf¹SO₂)₂, LiN(FSO₂)₂, and LiN(Rf¹SO₂)(Rf²SO₂) are preferable, and a lithiumimide salt such as LiPF₆, LiBF₄, LiN(Rf¹SO₂)₂, LiN(FSO₂)₂, and LiN(Rf¹SO₂)(Rf²SO₂) is still more preferable. Here, each of Rf¹ and Rf² represents a perfluoroalkyl group.

In addition, the electrolyte used in the electrolyte solution may be used singly or two or more types thereof may be arbitrarily used in combination.

The content of the lithium salt is preferably 0.1 parts by mass or greater and more preferably 0.5 parts by mass or greater with respect to 100 parts by mass of the solid electrolyte (A). The upper limit is preferably 10 parts by mass or less and more preferably 5 parts by mass or less.

(Positive Electrode Active Substance (E-1))

The positive electrode active substance is contained in the solid electrolyte composition according to the invention. In this manner, a composition for a positive electrode material can be made. Transition metal oxide is preferably used in the positive electrode active substance. Among them, transition metal oxide having a transition element M^{a} (1 type or more elements selected from Co, Ni, Fe, Mn, Cu, and V) is preferable. In addition, a mixed element M^{b} (an element in Group 1 (Ia) of the periodic table of metal other than lithium, an element in Group 2 (IIa), Al, Ga, In, Ge, Sn, Pb, Sb, Bi, Si, P, B, and the like) may be mixed. Examples of this transition metal oxide include a specific transition metal oxide including oxide expressed by any one of Formulae (MA) to (MC) below or include V₂O₅ and MnO₂, as additional transition metal oxide. A particle-state positive electrode active substance may be used in the positive electrode active substance. Specifically, it is possible to use a transition metal oxide to which a lithium-ion can be reversibly inserted or emitted, but it is preferable to use the specific transition metal oxide described above.

Examples of the transition metal oxide appropriately include oxide including the transition element M^{a}. At this point, the mixed element M^{b} (preferably Al) and the like are mixed. The mixture amount is preferably 0 mol % to 30 mol % with respect to the amount of the transition metal. It is more preferable that the transition element obtained by synthesizing elements such that the molar ratio of Li/M^{a} becomes 0.3 to 2.2.

[Transition Metal Oxide Expressed by Formula (MA) (Layered Rock Salt Structure)]

Among them, as the lithium-containing transition metal oxide, metal oxide expressed by the following formula is preferable.

LiₐM¹O_{b} (MA)

In the formula, M¹ has the same as M^{a} above. a represents 0 to 1.2 (preferably 0.2 to 1.2) and preferably represents 0.6 to 1.1. b represents 1 to 3, and preferably 2. A portion of M¹ may be substituted with the mixed element M^{b}. The transition metal oxide expressed by Formula (MA) above typically has a layered rock salt structure.

The transition metal oxide according to the invention is more preferably expressed by the following formulae.

Li_{g}CoOₖ (MA-1)

Li_{g}NiOₖ (MA-2)

Li_{g}MnOₖ (MA-3)

Li_{g}CoⱼNi₁₋ⱼOₖ (MA-4)

Li_{g}NiⱼMn₁₋ⱼOₖ (MA-5)

Li_{g}CoⱼNiᵢAl₁₋ⱼ₋ᵢOₖ (MA-6)

Li_{g}CoⱼNiᵢMn₁₋ⱼ₋ᵢOₖ (MA-7)

Here, g has the same meaning as a above. j represents 0.1 to 0.9. i represents 0 to 1. However, 1−j−i becomes 0 or greater. k has the same meaning as b above. Specific examples of the transition metal compound include LiCoO₂ (lithium cobalt oxide [LCO]), LiNi₂O₂ (lithium nickel oxide) LiNi_{0.85}Co_{0.01}Al_{0.05}O₂ (lithium nickel cobalt aluminum oxide [NCA]), LiNi_{0.33}Co_{0.33}Mn_{0.33}O₂ (lithium nickel cobalt manganese oxide [NMC]), and LiNi_{0.5}Mn_{0.5}O₂ (lithium manganese oxide).

Though partially overlapped, if the transition metal oxide expressed by Formula (MA) is indicated by changing the indication, the following are also provided as preferable examples.

(i) Li_{g}NiₓMn_{y}Co_{z}O₂ (x>0.2, y>0.2, z≧0, and x+y+z=1)

Representative Transition Metal Oxide:

Li_{g}Ni_{1/3}Mn_{1/3}CO_{1/3}O₂

Li_{g}Ni_{1/2}Mn_{1/2}O₂

(ii) Li_{g}NiₓCo_{y}Al_{z}O₂ (x>0.7, y>0.1, 0.1>z≧0.05, and x+y+z=1) Representative transition metal oxide:

Li_{g}Ni_{0.8}Co_{0.15}Al_{0.05}O₂

[Transition metal oxide expressed by Formula (MB) (Spinel-type structure)]

Among them, as the lithium-containing transition metal oxide, transition metal oxide expressed by Formula (MB) below is also preferable.

Li_{c}M²₂O_{d} (MB)

In the formula, M² has the same meaning as M^{a} above. c represents 0 to 2 (preferably 0.2 to 2) and preferably represents 0.6 to 1.5. d represents 3 to 5, and preferably represents 4.

The transition metal oxide expressed by Formula (MB) is more preferably transition metal oxide expressed by the following formulae.

LiₘMn₂Oₙ (MB-1)

LiₘMnₚAl₂₋ₚOₙ (MB-2)

LiₘMnₚNi₂₋ₚOₙ (MB-3)

m has the same meaning as c. n has the same meaning as d. p represents 0 to 2. Specific examples of the transition metal compound include LiMn₂O₄ and LiMn_{1.5}Ni_{0.5}O₄.

As the transition metal oxide expressed by Formula (MB), the following are also provided as preferable examples.

(a) LiCoMnO₄

(b) Li₂FeMn₃O₈

(c) Li₂CuMn₃O₈

(d) Li₂CrMn₃O₈

(e) Li₂NiMn₃O₈

Among the above, in view of high capacity and high output, an electrode including Ni is more preferable.

[Transition metal oxide expressed by Formula (MC)]

As the lithium-containing transition metal oxide, lithium-containing transition metal phosphorus oxide is preferably used. Among them, transition metal oxide expressed by Formula (MC) below is also preferable.

LiₑM³(PO₄)_{f} (MC)

In the formula, e represents 0 to 2 (preferably 0.2 to 2) and preferably 0.5 to 1.5. f represents 1 to 5 and preferably represents 0.5 to 2.

M³ above represents one or more types of elements selected from V, Ti, Cr, Mn, Fe, Co, Ni, and Cu. M³ above may be substituted with other metal such as Ti, Cr, Zn, Zr, and Nb, in addition to the mixed element M^{b} above. Specific examples thereof include an olivine-type iron phosphate salt such as LiFePO₄ and Li₃Fe₂(PO₄)₃, iron pyrophosphates such as LiFeP₂O₇, cobalt phosphates such as LiCoPO₄, and a monoclinic nasicon-type vanadium phosphate salt such as Li₃V₂(PO₄)₃ (vanadium lithium phosphate).

In addition, the values of a, c, g, m, and e representing the composition of Li are values that are changed depending on charging and discharging, and are typically evaluated by the values in a stable state when Li is contained. In Formulae (a) to (e) above, the composition of Li is indicated with specific values, but this is changed depending on an operation of the battery in the same manner.

According to the invention, the average particle diameter of the positive electrode active substance used is not particularly limited, but the average particle diameter is preferably 0.1 μm to 50 μm. In order to cause the positive electrode active substance to have a predetermined particle diameter, a general pulverizer and a general classifier may be used. The positive electrode active substance obtained by the baking method may be used after being washed with water, an acidic aqueous solution, an alkaline aqueous solution, or an organic dissolving agent. The method of measuring an average particle diameter of positive electrode active substance particles conforms to the method of measuring the average diameter of the inorganic particles described in the section of the examples below.

The concentration of the positive electrode active substance is not particularly limited, but the concentration in the solid electrolyte composition is preferably 20 mass % to 90 mass % and more preferably 40 mass % to 80 mass % with respect to 100 mass % of the solid component.

(Negative Electrode Active Substance (E-2))

The negative electrode active substance may be contained in the solid electrolyte composition according to the invention. In this manner, a composition for the negative electrode material can be made. As the negative electrode active substance, an active substance to which a lithium-ion can be reversibly inserted or emitted is preferable. The material is not particularly limited, and examples thereof include carbonaceous material, metal oxide such as tin oxide and silicon oxide, metal composite oxide, a single substance of lithium, a lithium alloy such as a lithium aluminum alloy, and metal that can form an alloy with lithium such as Sn or Si. These may be used singly or two or more types thereof may be used in arbitrary combinations and ratios. Among these, the carbonaceous material or lithium composite oxide is preferably used in view of reliability. In addition, as the metal composite oxide, metal composite oxide that can occlude or emit lithium is preferable. The material thereof is not particularly limited, but a material that contains titanium and/or lithium as the constituent component is preferable in view of characteristics at high current density.

The carbonaceous material used as the negative electrode active substance is a material that is substantially made of carbon. Examples thereof include petroleum pitch, natural graphite, artificial graphite such as vapor phase-grown graphite, and a carbonaceous material obtained by baking various synthetic resins such as a PAN-based resin or a furfuryl alcohol resin. Examples thereof further include various carbon fibers such as a PAN-based carbon fiber, a cellulose-based carbon fiber, a pitch-based carbon fiber, a vapor phase-grown carbon fiber, a dehydrated PVA-based carbon fiber, a lignin carbon fiber, a glass-state carbon fiber, and an active carbon fiber, a mesophase microsphere, a graphite whisker, and a flat plate-shaped graphite.

These carbonaceous materials may be divided into a hardly graphitizable carbon material and a graphite-based carbon material according to the degree of graphitization. In addition, the carbonaceous material preferably has surface intervals, density, and sizes of crystallite as disclosed in JP1987-22066A (JP-S62-22066A), JP1990-6856A (JP-H2-6856A), and JP1991-45473A (JP-H3-45473A). The carbonaceous material does not have to be a single material, and a mixture of natural graphite and artificial graphite disclosed in JP1993-90844A (JP-H5-90844A), graphite having a coating layer disclosed in JP1994-4516A (JP-H6-4516A), and the like can be used.

As the metal oxide and the metal composite oxide that are applied as the negative electrode active substance, amorphous oxide is particularly preferable, and, further, chalcogenide which is a reaction product of a metal element and an element in Group 16 in the periodic table can be preferably used. The expression “amorphous” herein means to have a broad scattering band having a vertex in an area of 20° to 40° in 20 values in the X-ray diffraction method using CuKα rays, and may have crystalline diffraction lines. The strongest strength of the crystalline diffraction lines seen at 40° to 70° in the 20 values is preferably 100 times or less and more preferably 5 times or less in the diffraction line intensity in the vertex of a broad scattering band seen at 20° to 40° in the 20 value, and it is particularly preferable that oxide does not have a crystalline diffraction line.

Among the compound groups made of amorphous oxide and chalcogenide, amorphous oxide and chalcogenide of a metalloid element are more preferable, and an element of Groups 13 (IIIB) to 15 (VB) in the periodic table, a single substance of Al, Ga, Si, Sn, Ge, Pb, Sb, or Bi or oxide made of a combination obtained by combining two or more types thereof, and chalcogenide are particularly preferable. Specific examples of preferable amorphous oxide and chalcogenide preferably include Ga₂O₃, SiO, GeO, SnO, SnO₂, PbO, PbO₂, Pb₂O₃, Pb₂O₄, Pb₃O₄, Sb₂O₃, Sb₂O₄, Sb₂O₅, Bi₂O₃, Bi₂O₄, SnSiO₃, GeS, SnS, SnS₂, PbS, PbS₂, Sb₂S₃, Sb₂S₅, and SnSiS₃. In addition, these may be composite oxide with lithium oxide, for example, Li₂SnO₂.

The average particle diameter of the negative electrode active substance is preferably 0.1 μm to 60 μm. In order to cause the negative electrode active substance to have a predetermined particle diameter, a well-known pulverizer and a well-known classifier are used. For example, a mortar, a ball mill, a sand mill, a vibrating ball mill, a satellite ball mill, a planetary ball mill, a swirling air stream-type jet mill, and a sieve are appropriately used. At the time of pulverizing, wet pulverization in which an organic solvent such as water or methanol coexist may be performed, if necessary. In order to obtain a desired particle diameter, classification is preferably performed. A pulverization method is not particularly limited, and a sieve, an air classifier, or the like can be used, if necessary. As the classification, both dry-type classification and wet-type classification can be used. The method of measuring the average particle diameter of the negative electrode active substance particles conforms to the method of measuring the average diameter of the inorganic particles indicated in the section of the examples below.

The chemical formula of the compound obtained by the baking method can be calculated in an induction coupling plasma (ICP) emission spectrophotometric analysis method as a measuring method or can be calculated from a mass difference between particles before and after baking, as a simple method.

Examples of the negative electrode active substance that can be used together with an amorphous oxide negative electrode active substance mainly using Sn, Si, and Ge appropriately include a carbon material that can occlude and emit lithium-ion, lithium metal or lithium, lithium alloy, or metal that can be formed to an alloy with lithium.

The negative electrode active substance preferably contains a titanium atom. More specifically, since the volume of Li₄Ti₅O₁₂ is small when a lithium-ion is occluded and emitted, quick charging-discharging properties are excellent, the deterioration of the electrode is prevented, and the lifespan of the lithium-ion secondary battery can be improved. Therefore, Li₄Ti₅O₁₂ is preferable. Stability of the secondary battery in various use condition improves due to the combination between a specific negative electrode and a further specific electrolyte solution.

The concentration of the negative electrode active substance is not particularly limited, but the concentration in the solid electrolyte composition is preferably 10 mass % to 80 mass % and more preferably 20 mass % to 70 mass % with respect to 100 mass % of the solid component.

In addition, the embodiment above describes an example in which a positive electrode active substance and a negative electrode active substance is contained in the solid electrolyte composition according to the invention, but the invention is not limited to thereto. For example, a paste including a positive electrode active substance and a negative electrode active substance as the binder composition that does not include the specific polymerizable compound (B) may be prepared. At this point, it is preferable that the solid electrolyte is contained. In this manner, the positive electrode material and the negative electrode material which are commonly used are combined, and the solid electrolyte composition relating to the preferable embodiment of the invention may be used to form a solid electrolyte layer. In addition, the conductive assistance may be appropriately contained in the active substance layer of the positive electrode and the negative electrode, if necessary. In a general conductive assistance, graphite, carbon black, acetylene black, Ketjen black, a carbon fiber, metal powders, a metal fiber, and a polyphenylene derivative, and the like can be included as the electron conductive material.

<Collector (Metallic Foil)>

It is preferable that an electron conductor that does not cause a chemical change is used as the collector of the positive•negative electrodes. As the collector of the positive electrode, in addition to aluminum, stainless steel, nickel, titanium, and the like, a product obtained by treating carbon, nickel, titanium, or silver on the surface of aluminum and stainless steel is preferable. Among them, aluminum and an aluminum alloy are more preferable. As the negative electrode collector, aluminum, copper, stainless steel, nickel, and titanium are preferable, and aluminum, copper, and a copper alloy are more preferable.

As the form of the collector, a sheet-shaped collector is commonly used, but a net, a punched collector, a lath body, a porous body, a foam body, a molded body of a fiber group, and the like can be used. The thickness of the collector is not particularly limited, but the thickness is preferably 1 μm to 500 μm. In addition, unevenness is preferably formed on the collector surface by a surface treatment.

<Manufacturing of all-Solid-State Secondary Battery>

Manufacturing of the all-solid-state secondary battery may be performed by the common method. Specifically, examples of the method include a method of making an electrode sheet for batteries on which a coating film is formed by applying the solid electrolyte composition on a metallic foil that becomes a collector. For example, after the composition that becomes the positive electrode material is applied on the metallic foil which is the positive electrode collector, drying is performed such that the positive electrode layer is formed. Subsequently, after the solid electrolyte composition is applied on the positive electrode sheet for batteries, drying is performed such that the solid electrolyte layer is formed. Further, after the composition that becomes the negative electrode material is applied, drying is performed such that the negative electrode layer is formed. Additionally, the structure of the all-solid-state secondary battery in which the solid electrolyte layer is inserted between the positive electrode layer and the negative electrode layer can be obtained by overlapping the collector (metallic foil) on the negative electrode side. In addition, the method of applying the respective compositions may be performed in the normal method. At this point, after the composition for making the positive electrode active substance layer, the composition (solid electrolyte composition) for making the inorganic solid electrolyte layer, and the composition for making the negative electrode active substance layer are respectively applied, a drying treatment may be performed, or after the multilayer application is performed, a drying treatment may be performed. The drying temperature is not particularly performed, but the drying temperature is preferably 30° C. or higher and more preferably 60° C. or higher. The upper limit is preferably 300° C. or lower and more preferably 250° C. or lower. If the heating is performed at this temperature range, the dispersion medium is removed, such that the solid electrolyte composition can be caused to be in the solid state. In this manner, in the all-solid-state secondary battery, satisfactory binding properties and ion conductivity in non-pressurization can be obtained.

<Use of all-Solid-State Secondary Battery>

The all-solid-state secondary battery according to the invention can be applied to various uses. The use aspect is not particularly limited, but, if the all-solid-state secondary battery is mounted in an electronic device, examples thereof include a notebook personal computer, a pen input personal computer, a mobile computer, an electron book player, a cellular phone, a cordless phone slave unit, a pager, a handy terminal, a portable fax machine, a portable copying machine, a portable printer, a headphone stereo, a video movie, a liquid crystal television, a handy cleaner, a portable CD, a mini disc, an electric shaver, a transceiver, an electronic organizer, a calculator, a memory card, a portable tape recorder, radio, and a backup power supply. In addition, examples of additional consumer use include an automobile, an electric motor vehicle, a motor, lighting equipment, a toy, a game machine, a load conditioner, a clock, a stroboscope, a camera, and medical equipment (a pacemaker, a hearing aid, and a shoulder massager). Further, the all-solid-state secondary battery can be used for military or space. In addition, the all-solid-state secondary battery can be combined with a solar battery.

Among these, the all-solid-state secondary battery is preferably applied to an application that requires discharging properties at high capacity and a high rate. For example, in an electric storage facility and the like in which high capacity enhancement is expected in the future, high reliability is necessary, and thus compatibility between battery properties is required. In addition, a high capacity secondary battery is mounted on an electric car and the like, a use in which charging is performed everyday at home is assumed, and reliability at overcharging is further required. According to the invention, an excellent effect can be achieved in response to these use forms.

According to the preferable embodiment of the invention, respective applications as follows are provided.

(1) A solid electrolyte composition (a composition for electrodes of a positive electrode or a negative electrode) that includes an active substance that can insert or emit ion of metal belonging to Group 1 or 2 of the periodic table.

(2) An electrode sheet for battery obtained by forming a film of a solid electrolyte composition on a metallic foil.

(3) An all-solid-state secondary battery including a positive electrode active substance layer, a negative electrode active substance layer, and a solid electrolyte layer, in which at least any one of the positive electrode active substance layer, the negative electrode active substance layer, and the solid electrolyte layer is a layer formed of a solid electrolyte composition.

(4) A method of manufacturing an electrode sheet for batteries by disposing the solid electrolyte composition on a metallic foil, and forming a film of the solid electrolyte composition.

(5) An all-solid-state secondary battery manufacturing method of manufacturing an all-solid-state secondary battery in the method of manufacturing an electrode sheet for batteries.

In addition, according to the preferable embodiment of the invention, binder particles can be formed without inputting a surfactant, and thus there is an advantage of decreasing an inhibiting factor such as the side reaction accompanied thereto. In addition, accordingly, a phase inversion emulsification step can be omitted, and this leads to relative improvement of manufacturing efficiencies.

The all-solid-state secondary battery refers to a secondary battery that is formed of a positive electrode, a negative electrode, and an electrolyte which are all solid. In other words, the all-solid-state secondary battery is different from an electrolyte solution-type secondary battery in which a carbonate-based solvent is used as an electrolyte. Among these, the invention relates to an inorganic all-solid-state secondary battery. The all-solid-state secondary battery is classified into the organic (high molecular) all-solid-state secondary battery using a high molecular compound such as polyethylene oxide as an electrolyte and the inorganic all-solid-state secondary battery using LLT, LLZ, or the like. In addition, a high molecular compound can be applied as binders of the positive electrode active substance, the negative electrode active substance, and the inorganic solid electrolyte particle, without preventing application to an inorganic all-solid-state secondary battery.

The inorganic solid electrolyte is different from the electrolyte (high molecular electrolyte) using a high molecular compound as an ion conducting medium, and the inorganic compound becomes an ion conducting medium. Specific examples thereof include LLT or LLZ above. The inorganic solid electrolyte itself does not emit a positive ion (Li ion), but exhibits an ion transporting function. In contrast, an electrolyte solution or a material that becomes a supply source of an ion that is added to a solid electrolyte layer and emits a positive ion (Li ion) is called an electrolyte, but when the electrolyte is differentiated from the electrolyte as the ion transferring material, the electrolyte is called an “electrolyte salt” or a “supporting electrolyte”. Examples of the electrolyte salt include lithium bistrifluoromethane sulfone imide (LiTFSI).

In this specification, the expression “composition” means a mixture in which two or more components are evenly mixed. However, evenness may be substantially maintained, and aggregation or uneven distribution may partially occur in a range in which a desired effect is exhibited.

### EXAMPLES

Hereinafter, the invention is specifically described with reference to examples, but the invention is not limited thereto. In the examples below, the expressions “part” and “%” are on a mass basis, unless otherwise described.

### Examples 1

### Comparative Example 1

### Synthesization Example of Resin

7.2 g of a 40%-by-mass heptane solution of a macromonomer M-1, 12.4 g of methyl acrylate (manufactured by Wako Pure Chemical Industries, Ltd.), 6.7 g of methyl methacrylate (manufactured by Wako Pure Chemical Industries, Ltd.), 207 g of heptane (manufactured by Wako Pure Chemical Industries, Ltd.), and 1.4 g of azoisobutyronitrile were added to a 2-L three-necked flask provided with a reflux cooling tube and a gas introducing cock, nitrogen gas was introduced at a flow velocity of 200 mL/min for 10 minutes, and then a temperature was increased to 100° C. A liquid (a liquid in which 93.1 g of a 40%-by-mass heptane solution of the macromonomer M-1, 222.8 g of methyl acrylate, 120.0 g of methyl methacrylate, 300.0 g of heptane, and 2.1 g of azoisobutyronitrile were mixed) prepared in a separate container was dripped over 4 hours. After the dripping was completed, 0.5 g of azoisobutyronitrile was added. Thereafter, the resultant was stirred for 2 hours at 100° C. and was cooled to room temperature, and was filtrated so as to obtain a dispersion liquid of a resin B-1. The solid component concentration was 39.2% and the particle diameter was 198 nm.

Other exemplary binders can be prepared in the same manner (see Table 1 below).

<Synthesization Example of Macromonomer M-1>

The macromonomer M-1 was obtained by reacting glycidyl methacrylate (manufactured by Tokyo Chemical Industry Co., Ltd.) with a self-condensated body (GPC polystyrene standard number average molecular weight: 2,000) of 12-hydroxystearic acid (manufactured by Wako Pure Chemical Industries, Ltd.) and polymerizing this with methyl methacrylate and glycidyl methacrylate (manufactured by Tokyo Chemical Industry Co., Ltd.) in the ratio of 1:0.99:0.01 (molar ratio) so as to obtain a polymer, as a macromonomer, and reacting this polymer with an acrylic acid (manufactured by Wako Pure Chemical Industries, Ltd.). The SP value of the macromonomer M-1 was 9.3 and the number average molecular weight was 11,000.

The estimated structural formulae of the synthesized macromonomer and polymer are provided below.

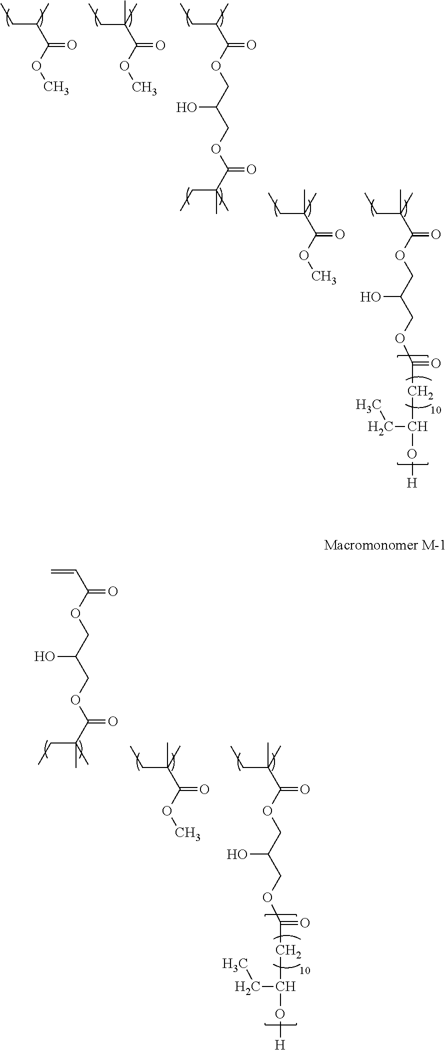

TABLE 1

| Binder | MC1 | Parts | MC2 | Parts | MC3 | Parts | MC4 | Parts | MM | Parts |
|---|---|---|---|---|---|---|---|---|---|---|
| B-1 | A-3 | 65 | A-4 | 35 | | | | | M-1 | 11 |
| B-2 | A-3 | 90 | A-27 | 10 | | | | | M-1 | 11 |
| B-3 | A-3 | 20 | A-14 | 80 | | | | | M-1 | 11 |
| B-4 | A-1 | 2 | A-3 | 20 | A-7 | 76 | A-31 | 2 | M-1 | 11 |
| B-5 | A-3 | 50 | A-4 | 50 | | | | | M-1 | 11 |
| B-7 | A-3 | 65 | A-4 | 35 | | | | | M-1 | 11 |
| B-8 | A-4 | 70 | A-42 | 30 | | | | | M-1 | 11 |

<Explanatory Notes of Table>

Numbers in the table are indicated by parts by mass (indicated such that the content of the main chain component becomes 100 parts)

With respect to numbers of compounds, see examples of the exemplary compound

MC: Monomer forming a main chain

MM: Monomer (macromonomer) forming a side chain

(Preparation Example of Solid Electrolyte Composition)

180 zirconium beads having a diameter of 5 mm were input to a 45-mL container (manufactured by Fritsch Japan Co., Ltd.), 9.5 g of an inorganic solid electrolyte LLT (manufactured by Toshima Manufacturing Co., Ltd.), 0.5 g (solid component weight) of the binder B-1, and 15.0 g of heptane as the dispersion medium were input, a container was set in a planet ball mill manufactured by Fritsch Japan Co., Ltd., and mixing was continued for 2 hours at a revolution number of 300 rpm, so as to obtain a solid electrolyte composition S-2. The average diameter of the prepared solid electrolyte particle was 50 μm. Exemplary solid electrolyte compositions except for the composition T-2 were prepared in the same manner.

TABLE 2

| Composition | Solid electrolyte | | Binder | | Dispersion medium |
|---|---|---|---|---|---|
| S-1 | LLT | 90 | B-1 | 10 | Heptane |
| S-2 | LLT | 95 | B-1 | 5 | Heptane |
| S-3 | LLT | 95 | B-2 | 5 | Heptane |
| S-4 | LLT | 95 | B-3 | 5 | Heptane |
| S-5 | LLT | 95 | B-4 | 5 | Heptane |
| S-6 | LLT | 95 | B-5 | 5 | Heptane |
| S-8 | LLT | 95 | B-2 | 5 | MEK |
| S-9 | LLZ | 95 | B-1 | 5 | Heptane |
| S-10 | LLT | 95 | B-7 | 5 | Heptane |
| S-11 | LLT | 95 | B-8 | 5 | Heptane |
| T-1 | LLT | 100 | — | — | Heptane |
| T-2 | LLT | 95 | PTFE | 5 | — |
| T-3 | LLT | 95 | HSBR | 5 | Heptane |
| T-4 | LLT | 95 | PEO | 5 | Heptane |

<Explanatory Notes of Table>

Numbers in the table are indicated by mass ratios (%)

With respect to numbers of compounds, see examples of the exemplary compound

LLT: Li_{0.33}La_{0.55}TiO₃

LLZ: Li₇La₃Zr₂O₁₂

PTFE: polytetrafluoroethylene

MEK: methylethylketone

HSBR: Hydrogen-added styrene-butadiene rubber

PEO: Polymer particles obtained by the following synthesization method

700 parts of n-butyl acrylate, 200 parts of styrene, 5 parts of methacrylic acid, 10 parts of divinylbenzene, 25 parts of polyoxyethylene lauryl ether (manufactured by Kao corporation, EMULGEN 108, a non-ionic surfactant, an alkyl group having 12 carbon atoms, HLB value: 12.1) as a an emulsifier, 1,500 parts of ion exchange water, and 15 parts of azobisbutyronitrile as a polymerization initiator were input to an autoclave and sufficiently stirred. Thereafter, a temperature was raised to 80° C. so as to perform polymerization. Also, after the polymerization was started, cooling was performed so as to stop polymerization reaction, so as to obtain latex of polymer particles. An average diameter was 120 nm.

(Preparation Example of Solid Electrolyte Composition T-2)

180 zirconium beads having a diameter of 5 mm were input to a 45-mL container manufactured with zirconium (manufactured by Fritsch Japan Co., Ltd.), 9.5 g of an inorganic solid electrolyte LLT (manufactured by Toshima Manufacturing Co., Ltd.), 0.5 g of PTFE particles as a binder were input, a container was set to a planet ball mill manufactured by Fritsch Japan Co., Ltd., and mixing was continued for 2 hours at a revolution number of 300 rpm, so as to obtain a solid electrolyte composition T-2.

(Manufacturing Example of Solid Electrolyte Sheet)

The solid electrolyte composition obtained above was applied on an aluminum foil having a thickness of 20 μm, with an applicator having arbitrary clearance, and heating was performed for 1 hour at 80° C. and further performed for 1 hour at 110° C., so as to dry the applied solvent. Thereafter, a copper foil having a thickness of 20 μm was matched, and heating and pressurizing were performed by using a heat press machine so as to have an arbitrary density, such that a solid electrolyte sheet was obtained. The film thickness of the electrolyte layer was 30 μm. The other solid electrolyte sheet was prepared in the same manner.

(Preparation Example of Composition for Secondary Battery Positive Electrode)

100 parts of the positive electrode active substance (average diameter of 10 μm) presented in Table 3, 5 parts of acetylene black, 75 parts of the solid electrolyte composition S-1 obtained above, and 270 parts of MEK were added to a planetary mixer (TK HIVIS MIX, manufactured by PRIMIX Corporation), and were stirred for one hour at 40 rpm.

(Preparation Example of Composition for Secondary Battery Negative Electrode)

The negative electrode active substance presented in Table 3, 5 parts of acetylene black, 75 parts of the solid electrolyte composition S-1 obtained above, and 270 parts of MEK were added to a planetary mixer (TK HIVIS MIX, manufactured by PRIMIX Corporation), and were stirred for one hour at 40 rpm.

(Manufacturing Example of Positive Electrode Sheet for Secondary Battery)

The composition for the secondary battery positive electrode obtained above was applied on an aluminum foil having a thickness of 20 μm with an applicator having arbitrary clearance, and heating was performed for 1 hour at 80° C. and further performed for 1 hour at 110° C., so as to dry the applied composition. Thereafter, heating and pressurizing were performed by using a heat press machine so as to have an arbitrary density, such that a positive electrode sheet for a secondary battery was obtained.

Negative electrode sheets for secondary batteries except for Comparative Example c12 were able to be prepared in the same method.

(Manufacturing Example of Electrode Sheet for Secondary Battery)

The solid electrolyte composition obtained above was applied on the positive electrode sheet for the secondary battery obtained above with an applicator having arbitrary clearance, and heating was performed for 1 hour at 80° C. and further performed for 1 hour at 110° C., so as to dry the solid electrolyte composition.

Thereafter, the composition (which is not applied when a solid electrolyte sheet was created) for the secondary battery negative electrode obtained above is further applied, and heating was performed for 1 hour at 80° C. and further performed for 1 hour at 110° C., so as to dry the composition. Thereafter, a copper foil having a thickness of 20 μm was matched on the negative electrode layer, and heating and pressurizing were performed by using a heat press machine so as to have an arbitrary density, such that an electrode sheet for a secondary battery was obtained. At this point, the respective compositions were able to be applied at the same time, or applying, drying, and pressing was able to be performed simultaneously/sequentially. The respective compositions were able to be stacked by transferring after the respective compositions were applied on another base material.

(Manufacturing Example of Comparative Example c12)

A sheet-shaped solid electrolyte sheet was obtained by pressurizing and molding the solid electrolyte composition T-2 obtained above so as to have an arbitrary density. A cell for electrochemical measurement was manufactured by cutting the manufactured sheet so as to have a disc shape with a diameter of 14.5 mm, interposing an aluminum foil of 20 μm therebetween, and using a coin battery member.

<Evaluation of Binding Properties>

Sellotape (Registered trademark) (Product name, manufactured by Nichiban Co., Ltd.) having a width of 12 mm and a length of 60 mm was applied to the solid electrolyte sheet or the positive electrode sheet for the secondary battery, 50 mm of Sellotape was peeled off at a speed of 10 mm/min, and then binding properties were evaluated by a ratio of an area of the peeled portion. The measuring was performed 10 times, and an average of 8 times except for which a maximum value and a minimum value was employed. 5 samples for respective levels were used as test samples, and an average value thereof was employed. In addition, as the value of the binding property evaluation of the electrolyte sheet, the above evaluation results in the positive electrode sheet for the secondary battery were used.

5: 0%

4: greater than 0% and less than 5%

3: 5% or greater and less than 20%

2: 20% or greater and less than 50%

1: 50% or greater

<Measuring of Ion Conductance>

A coin battery was manufactured by cutting the solid electrolyte sheet obtained above or the secondary battery electrode sheet obtained above into a disc shape with a diameter of 14.5 mm and inputting the cut solid electrolyte sheet or the cut secondary battery electrode sheet to a stainless steel 2032-type coin case combined with a spacer or a washer (when the solid electrolyte sheet was used, an aluminum foil cut into a disc shape with a diameter of 14.5 mm was put into the coin case so as to come into contact with a solid electrolyte layer). The coin battery was inserted from the outside of the coin battery in a jig that can apply a pressure between electrodes to be used in the electrochemical measurement. The pressure between the electrode was 500 kgf/cm².

The obtained coin battery was used, the 1255B frequency response analyzer manufactured by SOLARTRON was used in a thermostatic bath at 30° C., and an alternating current impedance in a voltage amplitude of 5 mV and a frequency from 1 MHz to 1 Hz was measured, the resistance of the specimen in the film thickness direction was obtained, and thus the ion conductance was obtained by the calculation of Formula (1) below. At this point, a test body illustrated in FIG. 2 was used for pressurizing the battery. Reference numeral 11 is an upper support plate, reference numeral 12 is a lower support plate, reference numeral 13 is a coin battery, reference numeral 14 is a coin case, reference numeral 15 is an electrode sheet (a solid electrolyte sheet or a secondary battery electrode sheet), and reference numeral S is a screw.

Ion conductance (mS/cm)=1,000×specimen film thickness (cm)/(resistance (Ω)×specimen area (cm²)) Formula (1)

<Measuring of Particle Diameter>

(Measuring of Average Diameter of Binder)

The measuring of the average diameter of the binder particles is performed in the following method. A 1%-by-mass dispersion liquid was prepared by using the binder prepared above in an arbitrary solvent (a dispersion medium used in the preparation of the solid electrolyte composition. Heptane in the case of the binder B-1). A volume average diameter of the resin particles was measured with the dispersion liquid specimen by using a laser diffraction/scattering particle size distribution measuring apparatus LA-920 (manufactured by HORI BA, Ltd.).

(Measuring of Average Diameter of Inorganic Particles)

The measuring of the average diameter of the inorganic particles was performed in the following sequence. A 1%-by-mass dispersion liquid was prepared by using the inorganic particles in water (heptane, in the case of a material which is unstable in water). A volume average diameter of the inorganic particles was measured with the dispersion liquid specimen by using a laser diffraction/scattering particle size distribution measuring apparatus LA-920 (manufactured by HORIBA Ltd.).

<Method of Measuring Tg>

The glass transition point was measured with the dried specimen by using a differential scanning calorimeter (manufactured by SIT Technologies Pvt. Ltd., DSC7000) under the following conditions. The measuring was performed twice with the same specimen, and the second measurement result was employed.
Atmosphere in measuring chamber: Nitrogen (50 mL/min)
Temperature elevation rate: 5° C./min
Measurement starting temperature: −100° C.
Measurement ending temperature: 200° C. (250° C. for c12)
Specimen pan: Aluminum pan
Mass of measurement specimen: 5 mg
Calculation of Tg: Intermediate temperature between lowering starting point and lowering ending point in a DSC chart was Tg

TABLE 3

| | Cell configuration | | | | | | Ion conductance (mS/cm) | |
|---|---|---|---|---|---|---|---|---|
| | Positive | Electrolyte | Negative | Binder | | Binding | Pressurized | Non- |
| Example | electrode | layer | electrode | Diameter (nm) | Tg (° C.) | properties | state | pressurized state |
| 101 | — | S-1 | — | 198 | 28 | 5 | 0.15 | 0.13 |
| 102 | LMO | S-1 | Graphite | 198 | 28 | 5 | 0.11 | 0.10 |
| | S-1 | | S-1 | | | | | |
| 103 | — | S-2 | — | 198 | 28 | 5 | 0.16 | 0.15 |
| 104 | LMO | S-2 | LTO | 198 | 28 | 5 | 0.12 | 0.11 |
| | S-2 | | S-2 | | | | | |
| 105 | LCO | S-2 | Graphite | 198 | 28 | 5 | 0.12 | 0.11 |
| | S-2 | | S-2 | | | | | |
| 106 | — | S-3 | — | 181 | 23 | 5 | 0.16 | 0.15 |
| 107 | NMC | S-3 | Graphite | 181 | 23 | 5 | 0.12 | 0.11 |
| | S-3 | | S-3 | | | | | |
| 108 | — | S-4 | — | 177 | −20 | 5 | 0.18 | 0.18 |
| 109 | NMC | S-4 | LTO | 177 | −20 | 5 | 0.13 | 0.13 |
| | S-4 | | S-4 | | | | | |
| 110 | — | S-5 | — | 152 | −22 | 5 | 0.16 | 0.16 |
| 111 | LMO | S-5 | LTO | 152 | −22 | 5 | 0.12 | 0.12 |
| | S-5 | | S-5 | | | | | |
| 112 | — | S-6 | — | 185 | 38 | 4 | 0.15 | 0.13 |
| 113 | NMC | S-6 | Graphite | 185 | 38 | 4 | 0.11 | 0.1 |
| | S-6 | | S-6 | | | | | |
| 114 | — | S-8 | — | 181 | 23 | 5 | 0.16 | 0.15 |
| 115 | LMO | S-8 | LTO | 181 | 23 | 5 | 0.12 | 0.11 |
| | S-8 | | S-8 | | | | | |
| 116 | — | S-9 | — | 198 | 28 | 5 | 0.16 | 0.15 |
| 117 | NMC | S-9 | Graphite | 198 | 28 | 5 | 0.12 | 0.11 |
| | S-9 | | S-9 | | | | | |
| 118 | — | S-10 | — | 886 | 28 | 4 | 0.16 | 0.14 |
| 119 | NMC | S-10 | LTO | 886 | 28 | 4 | 0.12 | 0.10 |
| | S-10 | | S-10 | | | | | |
| 120 | — | S-11 | — | 183 | 28 | 5 | 0.18 | 0.16 |
| 121 | NMC | S-11 | LTO | 183 | −11 | 5 | 0.13 | 0.11 |
| | S-11 | | S-11 | | | | | |
| c11 | — | T-1 | — | — | — | 1 | 0.14 | 0.02 |
| c12 | — | T-2 | — | 289 | 207 | 1 | 0.13 | 0.03 |
| c13 | — | T-3 | — | — | −57 | 2 | 0.12 | 0.04 |
| c14 | — | T-4 | — | 120 | −23 | 3 | 0.11 | 0.07 |

<Explanatory note of table>
LMO; LiMn₂O₄ lithium manganese oxide
LTO; 100 parts of Li₄Ti₅O₁₂ lithium titanium oxide (Product name “ENERMIGHT LT-106”, manufactured by Ishihara Sangyo Kaisha, Ltd.) (average diameter 6 μm)
LCO; LiCoO₂ lithium cobalt oxide
NMC; Li(Ni_{1/3}Mn_{1/3}Co_{1/3})O₂ Nickel, manganese, lithium cobalt oxide

### Example 2

The respective evaluations were performed for the resin composition B-1 in the same manner except that the macromonomer was changed from M-2 to M-5. As a result, satisfactory performances were exhibited as seen in Table 4.

TABLE 4

| | | | | MM | | Binder | | | Ion conductance (mS/cm) | |
|---|---|---|---|---|---|---|---|---|---|---|
| | Monomer | | | SP | Molecular | Diameter | | Binding | | Non- |
| Examples | #1 | #2 | #3 | Value | weight | (nm) | Tg (° C.) | properties | Pressurized | pressurized |
| 101 | A-3 | A-4 | M-1 | 9.3 | 11 | 198 | 28 | 5 | 0.15 | 0.13 |
| 201 | A-3 | A-4 | M-2 | 9.2 | 9 | 174 | 26 | 5 | 0.15 | 0.13 |
| 202 | A-3 | A-4 | M-3 | 9.2 | 13 | 185 | 27 | 5 | 0.14 | 0.12 |
| 203 | A-3 | A-4 | M-4 | 7.3 | 100 | 195 | 41 | 5 | 0.15 | 0.11 |
| 204 | A-3 | A-4 | M-5 | 9.1 | 6 | 188 | −37 | 5 | 0.14 | 0.12 |

MM: Macromonomer
Molecular weight: Number average molecular weight (×1000)

(Synthesization Example of the Macromonomer M-2)

The macromonomer M-2 was obtained by reacting glycidyl methacrylate (manufactured by Tokyo Chemical Industry Co., Ltd.) with a self-condensated body (GPC polystyrene standard number average molecular weight: 2,000) of a 12-hydroxystearic acid (manufactured by Wako Pure Chemical Industries, Ltd.). The ratio of a 12-hydroxystearic acid and glycidyl methacrylate was 99:1 (molar ratio). The SP value of the macromonomer M-2 was 9.2, and the number average molecular weight was 9,000.

An estimated structure of the macromonomer M-2 is as follows.

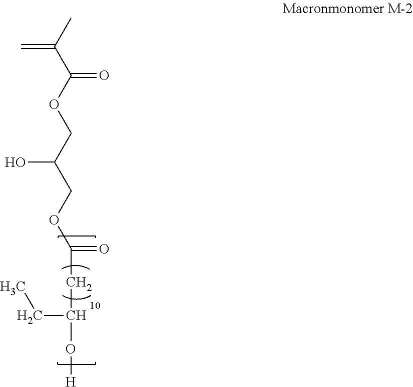

(Synthesization Example of Macromonomer M-3)

A macromonomer M-3 was obtained by reacting 4-hydroxystyrene (manufactured by Wako Pure Chemical Industries, Ltd.) with a self-condensated body (GPC polystyrene standard number average molecular weight: 2,000) of a 12-hydroxystearic acid (manufactured by Wako Pure Chemical Industries, Ltd.). The ratio of a 12-hydroxystearic acid and 4-hydroxystyrene was 99:1 (molar ratio). The SP value of the macromonomer M-3 was 9.2, and the number average molecular weight was 13,000.

(Synthesization Example of Macromonomer M-4)

A macromonomer M-4 (GPC polystyrene standard number average molecular weight: 100,000) was obtained by reacting glycidyl methacrylate (manufactured by Tokyo Chemical Industry Co., Ltd.) with the functional group-containing fluoroethylene•vinyl ether copolymer (Fluon PFA adhesive grade: manufactured by Asahi Glass Co., Ltd.). The ratio of the fluoroethylene•vinyl ether copolymer (manufactured by Asahi Glass Co., Ltd.) and glycidyl methacrylate was 99:1 (molar ratio). The SP value of the macromonomer M-4 was 7.3.

(Macromonomer M-5)

One-terminal methacryloylated poly-n-butylacrylate oligomer (Mn=6,000, Product name: AB-6, manufactured by Toagosei Co., Ltd.) was used as a macromonomer M-5. The SP value of the macromonomer M-5 was 9.1.

### Example 3

### Comparative Example 2

The respective evaluations were performed for the example 101 above in the same manner except that a particle diameter of the binder was changed. As a result, satisfactory performances were exhibited as seen in Table 5. At this point, the change of the particle diameters were performed by changing dripping speeds.

TABLE 5

| | | | | MM | | Binder | | | Ion conductance (mS/cm) | |
|---|---|---|---|---|---|---|---|---|---|---|
| | Monomer | | | SP | Molecular | Diameter | | Binding | | Non- |
| Examples | #1 | #2 | #3 | Value | weight | (nm) | Tg (° C.) | properties | Pressurized | pressurized |
| 101 | A-3 | A-4 | M-1 | 9.3 | 11 | 198 | 28 | 5 | 0.15 | 0.13 |
| 301 | A-3 | A-4 | M-1 | 9.3 | 10 | 1083 | 28 | 4 | 0.13 | 0.08 |

MM: Macromonomer
Molecular weight: Number average molecular weight (×1000)

### Example 4

In the condition of the test 101, the above tests were performed in the same manner except that A-3 of the binder B-1 was changed to A-19 and A-44, and A-27 of the binder B-2 was changed to A-26 and A-56 (all average diameters were about 200 nm), respectively. As a result, it was confirmed that satisfactory ion conductance at the time of non-pressurizing was able to be obtained in all solid electrolyte sheets and secondary battery electrode sheets.

The invention is described with reference to specific embodiments, but, unless described otherwise, it is clear that any details are not intended to limit the invention, and the embodiments are widely construed without departing from the spirit and the scope of the invention recited in the accompanying claims.

### REFERENCE NUMERALS AND SYMBOLS

1 negative electrode collector
2 negative electrode active substance layer
3 solid electrolyte layer
4 positive electrode active substance layer
5 positive electrode collector
6 operating position
10 all-solid-state secondary battery
11 upper support plate
12 lower support plate
13 coin battery
S screw

What is claimed is:

1. A solid electrolyte composition comprising:
an inorganic solid electrolyte (A) having conductivity of an ion of metal belong to Group 1 or 2 in the periodic table;
binder particles (B) formed of a polymer combined with a macromonomer (X) having a number average molecular weight of 1,000 or greater, as a side chain component, and which has an average diameter of 10 nm to 1,000 nm; and
a dispersion medium (C).

2. The solid electrolyte composition according to claim 1,
wherein a polymer that forms in the binder particles (B) is amorphous.

3. The solid electrolyte composition according to claim 1,
wherein a glass transition temperature (Tg) of the polymer forming the binder particle is 30° C. or lower.

4. The solid electrolyte composition according to claim 1,
wherein the polymer forming the binder particle has at least one functional group in a group of functional groups (b).
Group of functional groups (b)
a carbonyl group, an amino group, a sulfonic acid group, a phosphoric acid group, a hydroxy group, an ether group, a cyano group, and a thiol group

5. The solid electrolyte composition according to claim 1,
wherein a carbonyl group is included in the polymer forming the binder particle.

6. The solid electrolyte composition according to claim 1,
wherein a polymer forming the binder particle includes a repeating unit derived from a monomer selected from a (meth)acrylic acid monomer, a (meth)acrylic acid ester monomer, and (meth)acrylonitrile.

7. The solid electrolyte composition according to claim 1,
wherein an average diameter of the binder particles (B) is 200 nm or lower.

8. The solid electrolyte composition according to claim 1,
wherein a ratio of a repeating unit derived from the macromonomer (X) in the polymer forming the binder particles (B) is 50 mass % or lower or 1 mass % or greater.

9. The solid electrolyte composition according to claim 1,
wherein a SP value of the macromonomer (X) is 10 or lower.

10. The solid electrolyte composition according to claim 1,
wherein the macromonomer (X) includes a polymerizable double bond and a straight chain hydrocarbon structure unit having 6 or more carbon atoms.

11. The solid electrolyte composition according to claim 1,
wherein the macromonomer (X) is a monomer expressed by any one of Formulae (b-13a) to (b-13c) below or a monomer having a repeating unit expressed by any one of Formulae (b-14a) to (b-14c), 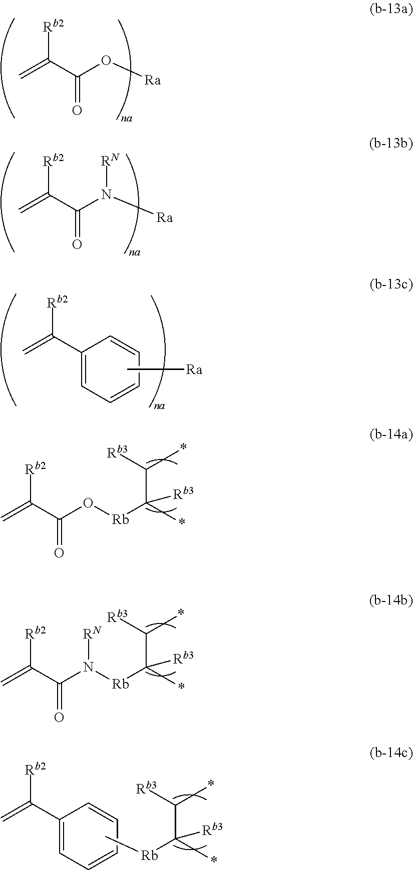
in the formulae, each of R^{b2} and R^{b3} independently represents a hydrogen atom, a hydroxy group, a cyano group, a halogen atom, an alkyl group, an alkenyl group, an alkynyl group, or an aryl group, each of Ra and Rb independently represents a linking group, but, when na is 1, Ra is a univalent substituent, na represents an integer of 1 to 6, and R^{N} is a hydrogen atom or a substituent.

12. The solid electrolyte composition according to claim 1, further comprising:
an active substance that can insert or emit an ion of metal belonging to Group 1 or 2 of the periodic table.

13. The solid electrolyte composition according to claim 1,
wherein a content of the binder particles (B) is 0.1 parts by mass to 20 parts by mass with respect to 100 parts by mass of the solid electrolyte (A).

14. The solid electrolyte composition according to claim 1,
wherein the dispersion medium (C) is selected from an alcohol compound solvent, an ether compound solvent, an amide compound solvent, a ketone compound solvent, an aromatic compound solvent, an aliphatic compound solvent, and a nitrile compound solvent.

15. An electrode sheet for batteries, obtained by forming a film of the solid electrolyte composition according to claim 1 on metallic foil.

16. An all-solid-state secondary battery comprising:
a positive electrode active substance layer;
a negative electrode active substance layer; and
a solid electrolyte layer,
wherein at least any one of the positive electrode active substance layer, the negative electrode active substance layer, and the solid electrolyte layer is a layer comprising: an inorganic solid electrolyte (A) having conductivity of an ion of metal belong to Group 1 or 2 in the periodic table; and binder particles (B) formed of a polymer combined with a macromonomer (X) having a number average molecular weight of 1,000 or greater, as a side chain component, and which has an average diameter of 10 nm to 1,000 nm.

17. A method of manufacturing an electrode sheet for batteries, comprising:
disposing the solid electrolyte composition according to claim 1 on a metallic foil; and
forming a film with the solid electrolyte composition.

18. A method of manufacturing an all-solid-state secondary battery comprising:
manufacturing an all-solid-state secondary battery using the method of manufacturing an electrode sheet for batteries according to claim 17.
